(19) United States
(12) Patent Application Publication
(10) Pub. No.: US 2023/0340971 A1
(43) Pub. Date: Oct. 26, 2023

(54) WIRELESS ACTUATORS

(71) Applicant: Massachusetts Institute Of Technology, Cambridge, MA (US)

(72) Inventors: Seyed M. Mirvakili, Cambridge, MA (US); Ian Hunter, Cambridge, MA (US); Robert Langer, Cambridge, MA (US)

(21) Appl. No.: 17/910,677

(22) PCT Filed: Mar. 12, 2021
(86) PCT No.: PCT/US2021/022164

§ 371 Date: Sep. 9, 2022

Related U.S. Application Data
(60) Provisional application No. 62/989,084, filed on Mar. 13, 2020.

(51) Int. Cl. F15B 15/10; F15B 21/0427; F15B 21/06

(52) U.S. Cl. CPC F15B 15/103; F15B 21/0427; F15B 21/065; F15B 2211/62; F15B 2211/885

(57) ABSTRACT

A device that performs wireless actuation by inductive heating. The device includes a bladder configured to expand or retract, so as to change the bladder's interior area. The device also includes a container, fluidly coupled to the bladder via a connector, that houses a magnetic rod suspended in a fluid medium. The magnetic rod is configured to react to a magnetic field that produces a phase transition of the fluid medium, causing the fluid medium to be transferred to the bladder's interior area, via the connector, expanding the bladder. The device further includes an induction coil, disposed around the container, and the induction coil's first end is coupled to the container's interior. The device also includes an induction heater, coupled to the induction coil's second end, that powers the induction coil, such that the induction coil generates the magnetic field within the container.

### CROSS-REFERENCE TO RELATED APPLICATIONS

This application is a National Phase application under 35 U.S.C. 371 of PCT/US2021/022164, filed Mar. 12, 2021, which claims priority to U.S. Provisional Application No. 62/989,084, filed Mar. 13, 2020. This application is also a continuation-in-part of PCT Patent Application No. PCT/US2019/055658, filed Oct. 10, 2019, which claims priority to U.S. Provisional Application No. 62/743,606, filed Oct. 10, 2018. Each of these applications is hereby incorporated herein by reference in its entirety.

### TECHNICAL FIELD

The present invention relates to thermal and pneumatic actuators and methods for manufacturing and using them, and, more particularly, to governing such actuators by induction heating.

### BACKGROUND ART

Artificial muscles are materials or devices that can reversibly contract, expand, or rotate within a single integral structure due to an external stimulus (such as voltage, current, pressure or temperature).

Mimicking muscle-generated movements—such as locomotion, lifting, rotation, and bending—have been of a great interest for application in robotics and electromechanical systems, in a broader scheme, as discussed in S. M. Mirvakili et al., “Artificial Muscles: Mechanisms, Applications, and Challenges,” Adv. Mater., vol. 30, 1704407 (2018), incorporated herein by reference. To address this need, several categories of muscle-like actuators (known as artificial muscles) have been developed over the past several decades. Shape memory materials (excited via Joule heating, light, or induction heating) (as discussed in S. M. Mirvakili et al., “Fast Torsional Artificial Muscles from NiTi Twisted Yarns,” ACS Appl. Mater. Interfaces, vol. 9, 16321-16326 (2017); S. M. Mirvakili et al., “A torsional artificial muscle from twisted nitinol microwire,” Proc. SPIE 10163, 101630S1-101630S7 (2017); A. Lendlein et al., “Light-induced shape-memory polymers, Nature 434, 879-882 (2005); R. Mohr et al., Initiation of shape memory effect by inductive heating of magnetic nanoparticles in thermoplastic polymers,” Proceedings of the National Academy of Sciences 103, 10, 3540-3545 (2006); P. R. Buckley et al., “Inductively heated shape memory polymer for the magnetic actuation of medical devices,” IEEE transactions on biomedical engineering 53.10, 2075-2083 (2006), each incorporated herein by reference), dielectric elastomers (as discussed in E. Acome et al., “Hydraulically amplified self-healing electrostatic actuators with muscle-like performance,” Science, vol. 359, 61-65 (2018), hereinafter “Acome;” C. Christianson et al., “Translucent soft robots driven by frameless fluid electrode dielectric elastomer actuators,” Sci. Robot. 3, eaat1893 (2018), each incorporated herein by reference), hydraulic actuators (as discussed in Acome; N. Kellaris et al., “Peano-HASEL actuators: Muscle-mimetic, electrohydraulic transducers that linearly contract on activation,” Sci. Robot. 3, eaar3276 (2018); . Sridar et al., IEEE International Conference on Robotics and Automation, 4014-4021 (2016), each incorporated herein by reference), highly oriented thermo-responsive polymers (as discussed in C. S. Haines et al., “Artificial Muscles from Fishing Line and Sewing Thread,” Science, 343, 868-872 (2014); S. M. Mirvakili et al., “Multidirectional Artificial Muscles from Nylon,” Adv. Mater., 29, 1604734 (2017), each incorporated herein by reference), conducting polymers (as discussed in R. H. Baughman, “Conducting polymer artificial muscles, Synth. Met. 78, 339-353 (1996); K. Uh et al., An Electrolyte-Free Conducting Polymer Actuator that Displays Electrothermal Bending and Flapping Wing Motions under a Magnetic Field,” ACS Appl. Mater. Interfaces, 8, 1289-1296 (2016), each incorporated herein by reference), ionic polymer metal composites (as discussed in Y. Yan, et al., “Electroactive Ionic Soft Actuators with Monolithically Integrated Gold Nanocomposite Electrodes,” Adv. Mater. 29, 1606, 109 (2017); Q. Shen et al., “A multiple-shape memory polymer-metal composite actuator capable of programmable control, creating complex 3D motion of bending, twisting, and oscillation,” Sci. Rep. 6, 24462 (2016), each incorporated herein by reference), and pneumatic actuators (M. A. Robertson et al., “Soft Pneumatic Actuator Fascicles for High Force and Reliability,” Soft Robot. 4, 23-32 (2016); D. Yang et al., “Buckling Pneumatic Linear Actuators Inspired by Muscle,” Adv. Mater. Technol. 1, 1600055 (2016); M. De Volder et al., “Fabrication and control of miniature McKibben actuators,” Sens. Actuators Phys. 166, 111-116 (2011); E. W. Hawkes et al., “Design and implementation of a 300% strain soft artificial muscle,” IEEE International Conference on Robotics and Automation Stockholm, 4022-4029 (2016), each incorporated herein by reference) are among the highly developed materials for artificial muscles.

Owing to its design simplicity, pneumatic artificial muscles (PAMs, similar to hydraulic actuators) are among the most industrially applied and highly developed actuators. Pneumatic artificial muscles, in general, are made of a compliant bladder confined within a braided jacket, as in the McKibben artificial muscle depicted in FIGS. 1A-1D. McKibben artificial muscle, invented in the 1950's, is one of the early examples of soft pneumatic actuators which is made of a compliant bladder confined within a braided jacket. In FIGS. 1A-1B, asymmetric braiding is shown that creates linear actuation when the bladder is pressurized. FIG. 1A shows the bladder with the asymmetric braiding before pressurization, and FIG. 1B shows the bladder with the asymmetric braiding after pressurization. In FIGS. 1C-1D, removing one family of braids enables torsional actuation. FIG. 1C shows the bladder with such braids removed before pressurization, and FIG. 1D shows the bladder with such braids removed after pressurization.

Bending, torsional, and linear actuation have been demonstrated with PAMs, as discussed in Belding et al., “Slit Tubes for Semisoft Pneumatic Actuators,” Adv. Mater., vol. 30, 1704446 (2018), incorporated herein by reference. Pneumatic artificial muscles can generate power densities of up to 10 kW/kg and are relatively easy to make. Over the past decade, more advanced and integrated designs have been proposed for pneumatic artificial muscles and are usually categorized within the field of soft robotics. The actuation mechanism in soft robots is very similar to that of pneumatic artificial muscles in that a pressurized soft expandable material generates bending, torsional, and linear actuation. Robotic grippers and in general robotic arms are among the widely researched PAMs due to their potential of being widely deployed in industry, with examples shown in FIGS. 1K and 1L. FIG. 1K depicts a FlexShapeGripper by Festo AG & Co. KG. This gripping mechanism is inspired by the tongue of a chameleon. FIG. 1L shows a Bionic motion robotic arm by Festo.

PAMs can generate up to 36% strain with energy and power densities of up to 200 kJ/m³ and 1 MW/m³, respectively (as discussed in S. I. Rich et al., Untethered soft robotics. Nature Electronics 1, 102-112 (2018), incorporated herein by reference), mainly limited by the rigidity and geometry of their inflated membranes. However, newer designs have recently enhanced the performance in different aspects such as strain, manufacturability, and generating wide range of motions. For example, inspired by origami structures, it has been shown that linear contractions of 90% can be achieved by applying negative pressures of 60 kPa to an origami skeleton with a symmetrical zigzag geometry, as depicted in FIGS. 1E (before negative pressure applied) and 1F (after negative pressure applied), reproduced from Li et al., “Fluid-driven origami-inspired artificial muscles,” PNAS, 201713450 (2017) (hereinafter, “Li 2017”), which is incorporated herein by reference. According to Li 2017, these structures have demonstrated stresses of 600 kPa and peak power densities of around 2 kW/kg. Torsional and bending actuation functionalities have also been demonstrated by these structures. Also see R. L. Truby et al., “Soft Somatosensitive Actuators via Embedded 3D Printing,” Adv. Mater., (2018); Roche Ellen T. et al., “A Bioinspired Soft Actuated Material,” Adv. Mater., vol. 26, 1200-1206 (2014); N. W. Bartlett et al., A 3D-printed, functionally graded soft robot powered by Combustion, Science. 349, 161-165 (2015); M. Wehner et al., An integrated design and fabrication, strategy for entirely soft, autonomous robots, Nature. 536, 451-455 (2016); A. Miriyev et al., Soft material for soft actuators, Nat. Commun. 8, 596 (2017), each incorporated herein by reference.

An interesting approach, inspired by plant growth, has been recently proposed by Hawkes et al., “A soft robot that navigates its environment through growth,” Sci. Robot, vol. 2, eaan3028 (2017) (hereinafter, “Hawkes 2017”), incorporated herein by reference, which employs internal pressure to increase the displacement of a robotic arm. This robotic arm generates non-reversible actuation and can navigate its environment through growth, as depicted in FIGS. 1G-1J, reproduced from Hawkes 2017. FIG. 1G shows an implementation of artificial muscles in a soft robot that uses small pneumatic control chambers and a camera mounted on the tip for visual feedback of the environment. The camera is held in place by a cable running through the body of the robot. To queue an upward turn, the lower control chamber is inflated, as shown in FIG. 1H. As the body grows in length, material on the inflated side lengthens as it everts, as shown in FIG. 1I, resulting in an upward turn, as shown in FIG. 1J. Hawkes 2017 reported that a 0.28 m long arm can extend to 72 m, limited by the amount of compliant membrane on the spool.

Recently, new fabrication techniques such as molding and 3D printing have been used to fabricate PAMs that can generate bending and/or torsional actuation in addition to linear actuation. By using molding fabrication techniques, it has been shown that tunable biomimetic motion (mimicking the twisting motion of the heart during contraction) can be achieved by embedding pneumatic artificial muscles in a soft matrix. Thanks to the recent advances in 3D printing technologies, pneumatic artificial muscles and sensors now can be easily integrated into the design of soft robots. For example, miniature autonomous robots and soft somatosensitive actuators have been demonstrated using multi-material embedded 3D printing techniques.

One of the current key challenges that pneumatic artificial muscles for portable devices have been facing is the weight/size of the required equipment (e.g., compressors, valves, pump or pressurized cylinder). This challenge is addressed to some extent by using alternative techniques to generate the required pressure for actuation. For untethered applications, aside from supplying gas from a pressurized source, several novel techniques have been explored including some involving phase change materials (e.g., liquid-vapor transition of ethanol), combustion (e.g., butane and oxygen), as discussed in N. W. Bartlett et al., “A 3D-printed, functionally graded soft robot powered by combustion,” Science, vol. 349, 161-165 (2015), incorporated herein by reference; and gas evolution reactions (e.g., decomposition of hydrogen peroxide with platinum catalyst or consumption of oxygen and hydrogen with a fuel cell to make vacuum, or generating CO₂ from urea with a catalyzer), as discussed in M. Wehner et al., “An integrated design and fabrication strategy for entirely soft, autonomous robots,” Nature, vol. 536, 451-455 (2016) and T. M. Sutter et al., “Rubber muscle actuation with pressurized CO₂ from enzyme-catalyzed urea hydrolysis,” Smart Mater. Struct., 22, 094022 (2013), each incorporated herein by reference; chemically activating swelling/de-swelling (e.g., pH-sensitive hydrogels), as discussed in B. Tondu et al., “A pH-activated artificial muscle using the McKibben-type braided structure,” Sens. Actuators Phys., 150, 124-130 (2009); and phase change materials (e.g., ethanol and paraffin wax), as discussed in A. Miriyev et al., “Soft material for soft actuators,” Nat. Commun., vol. 8, 596 (2017), Z. Zhou et al., “A large-deformation phase transition electrothermal actuator based on carbon nanotube-elastomer composites,” J. Mater. Chem. B., vol. 4, 1228-1234 (2016), B. Liu et al., “A thermal bubble micro-actuator with induction heating,” Sens. Actuators Phys., 222, 8-14 (2015), and D. Sangian et al., “Thermally activated paraffin-filled McKibben muscles,” J. Intell. Mater. Syst. Struct., vol. 27, 2508-2516 (2016), each incorporated herein by reference. Phase changes in liquids, such as ethanol, can generate reversible actuation. Indeed, it has been demonstrated that linear expansions of up to 140% (900% unconstrained) with stresses of up to 1.3 MPa can be generated from a Joule heated porous polymeric matrix filled with ethanol. Most combustion and chemical reaction techniques are irreversible; therefore, the fuel should be replenished after several cycles. In contrast, phase change materials can reversibly generate volumetric expansion. For negative pressure operating actuators (having structures similar to accordion bellows), mechanisms involving a reduction in the number of gas molecules can be exploited. Examples are hydrogen fuel cells, oxidizers, and heating-cooling techniques for generating vacuums.

Inductive activation of actuators through thermal mechanisms involving shape memory polymer has been discussed by Buckley et al., “Inductively Heated Shape Memory Polymer for the Magnetic Actuation of Medical Devices,” Hatsopoulos Microfluids Laboratory Report, MIT (February 2006), incorporated herein by reference.

### SUMMARY OF THE EMBODIMENTS

In accordance with one embodiment of the invention, a device for wireless actuation includes a bladder having an inner surface and an outer surface. The inner surface forms an interior area, and the bladder is configured to expand or retract so as to change an area of the interior area. The device also includes a container fluidly coupled to the bladder via a connector. The container houses a magnetic rod suspended in a fluid medium. The magnetic rod is configured to interact with a magnetic field oscillation which produces a phase transition of the fluid medium, causing the fluid medium to be transferred to the interior area of the bladder via the connector and causing the bladder to expand. The device further includes an induction coil disposed around the container, a first end of the induction coil coupled to an interior of the container. The device also includes an induction heater coupled to a second end of the induction coil. The induction heater powers the induction coil, such that the induction coil generates the oscillating magnetic field within the interior of the container.

In some embodiments, the bladder is made of silicone rubber and/or is a compliant bladder. In some embodiments, the bladder is a robotic gripper or a soft robot that operates using pneumatic or hydraulic pressure. In some embodiments, the container is a glass syringe and/or made of a non-ferromagnetic material. In some embodiments, the fluid medium is an engineered fluid with a boiling point of 61 degrees Celsius. In some embodiments, the connector is a dispensing needle. In some embodiments, the container is sealed with a metallic plate. In some embodiments, the metallic plate is coupled to a heat sink.

In some embodiments, the magnetic rod is configured to increase in temperature due to interaction with the magnetic field and the increased temperature of the magnetic rod causes the phase transition of the fluid medium. In some embodiments, the phase transition of the fluid medium includes gas generated within the container by the magnetic rod, such that the gas is transferred to the interior area of the bladder via the connector and causes the bladder to expand. In some embodiments, the phase transition of the fluid medium causes the bladder to expand due to pressure caused by the gas within the interior area of the bladder. In some embodiments, a controller is in communication with the induction heater via a power switch and configured to control a voltage provided to the induction coil.

### BRIEF DESCRIPTION OF THE DRAWINGS

The foregoing features of embodiments will be more readily understood by reference to the following detailed description, taken with reference to the accompanying drawings, in which:

FIGS. 1A-1D is a block diagram of prior art McKibben artificial muscles.

FIGS. 1E-1F are diagrams depicting operation of a prior art origami-inspired artificial muscles (actuators).

FIGS. 1G-1J are diagrams showing a robot arm actuated by prior art pneumatic artificial muscles.

FIGS. 1K-1L are diagrams showing a prior art pneumatic artificial muscle functioning as a gripping mechanism.

FIGS. 2A-2B are block diagrams of a wireless actuation system functioning based on induction heating of magnetic particles in an alternating magnetic field, according to embodiments of the present invention.

FIG. 2C is a block diagram of materials used in the actuation system, according to embodiments of the present invention.

FIG. 3A is a scanning electronic microscope (SEM) image of magnetic particles used to generate actuation according to embodiments of the present invention.

FIG. 3B is a graph of the X-ray powder diffraction (XRD) patterns of a magnetic particles sample used to generate actuation according to embodiments of the present invention.

FIG. 3C is a graph of moments of power as a function of a magnetic field applied to a magnetic particles sample used to generate actuation according to embodiments of the present invention.

FIG. 3D is a graph of the temperature increase rate of a magnetic particles sample excited with a magnetic field according to embodiments of the present invention.

FIGS. 4A and 4B are images showing movement of a load before and after excitation of an actuator according to embodiments of the present invention.

FIGS. 4C and 4D are images showing temperature measurement of an actuation cycle of an actuator according to embodiments of the present invention.

FIG. 4E and 4F are images illustrating the pressure generated inside the bladder of an actuator according to embodiments of the present invention.

FIG. 4G is a graph illustrating the temperature profile of a magnetic particles sample during on-off excitation cycles according to embodiments of the present invention.

FIG. 4H is a graph illustrating strain curves of the actuator during multiple excitation cycles according to embodiments of the present invention.

FIG. 4I is a graph illustrating temperature and block force profiles for a sample under isometric conditions according to embodiments of the present invention.

FIG. 5A is a graph illustrating the force and strain of two magnetic particle samples at two different temperatures according to embodiments of the present invention.

FIG. 5B is a graph illustrating the lock strain or lock contraction of an actuator according to embodiments of the present invention after a first excitation cycle using carbonated water as the fluid medium of the actuator.

FIG. 5C is a graph illustrating the peak strain evolution of the actuator during successive excitation cycles according to embodiments of the present invention.

FIGS. 5D-5I are diagrams showing use of an actuator according to embodiments of the present invention as a robot arm under different loads.

FIG. 6 is a flow chart of generating wireless actuation according to embodiments of the present invention.

FIGS. 7A-7F are block diagrams showing dominant heating mechanisms used in embodiments of the present invention.

FIG. 8A is an apparatus used to examine heating power as a function of a magnetic field in an actuation mechanism according to embodiments of the present invention.

FIG. 8B is a graph of the temperature profile of the magnetic particles in the apparatus of FIG. 8A.

FIG. 8C is a graph of the initial rate of temperature increase as a function of magnetic field intensity in the apparatus of FIG. 8A.

FIG. 9A is a coil used in modeling and testing the actuation mechanism according to embodiments of the present invention.

FIG. 9B is a coil used to measure magnetic field characteristics in testing the actuation mechanism according to embodiments of the present invention.

FIG. 9C is a circuit schematic used to generate a high frequency alternating magnetic field for testing the actuation mechanism according to embodiments of the present invention.

FIG. 9D shows a graph of the magnetic field along the coil axis of the coil of FIG. 9B according to embodiments of the present invention.

FIG. 9E shows a graph of the magnetic field as a function of the input power for testing the actuation mechanism according to embodiments of the present invention.

FIG. 10A shows a graph of force versus strain of an apparatus according to embodiments of the present invention at two different temperature profiles.

FIG. 10B shows a graph of the change in differential pressure as a function of temperature in the apparatus of FIG. 10A.

FIG. 10C shows a graph of the change in volume as a function of temperature in the apparatus of FIG. 10A.

FIGS. 11A-11B are block diagrams of a wireless actuation system functioning based on an induction heater coupled to an induction coil, according to embodiments of the present invention.

FIG. 12 is a flow chart of generating wireless actuation according to embodiments of the present invention.

FIG. 13A is a top view of molds used to fabricate models of soft grippers according to embodiments of the present invention.

FIG. 13B is a side view of the molds of FIG. 13A.

FIG. 14 shows a graph of a duty cycle pattern used to excite a soft gripper according to embodiments of the present invention.

FIGS. 15A-15E are images of a soft gripper excited by the duty cycle pattern of FIG. 13 according to embodiments of the present invention.

FIGS. 16A-16F are images of excitation of a soft gripper according to embodiments of the present invention.

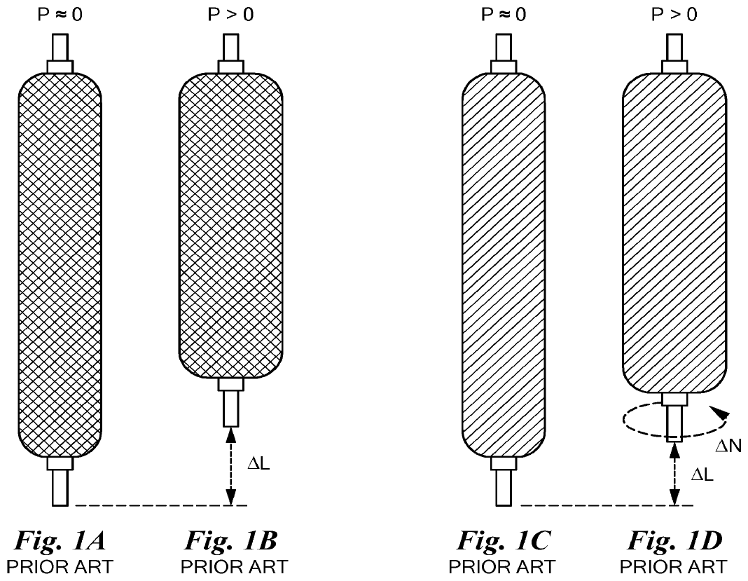

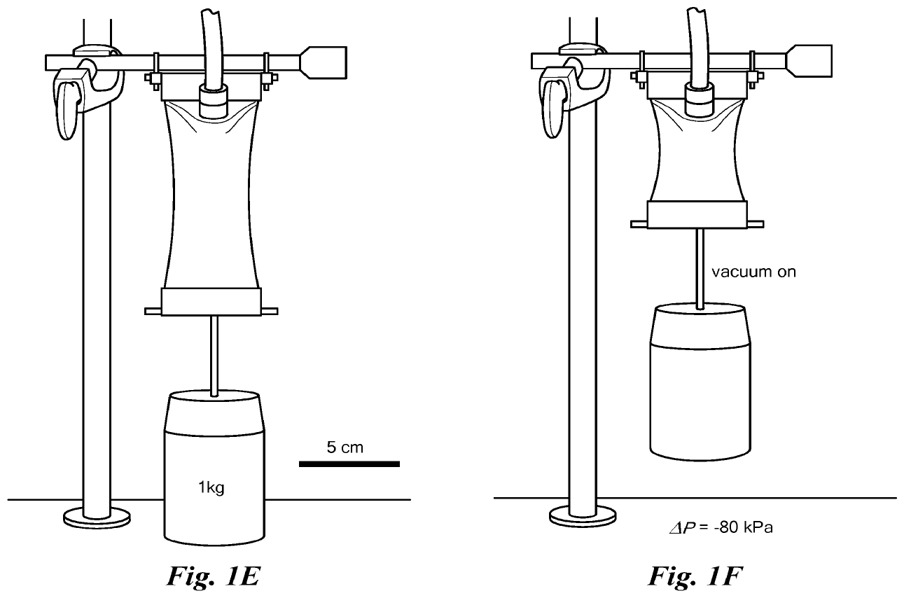

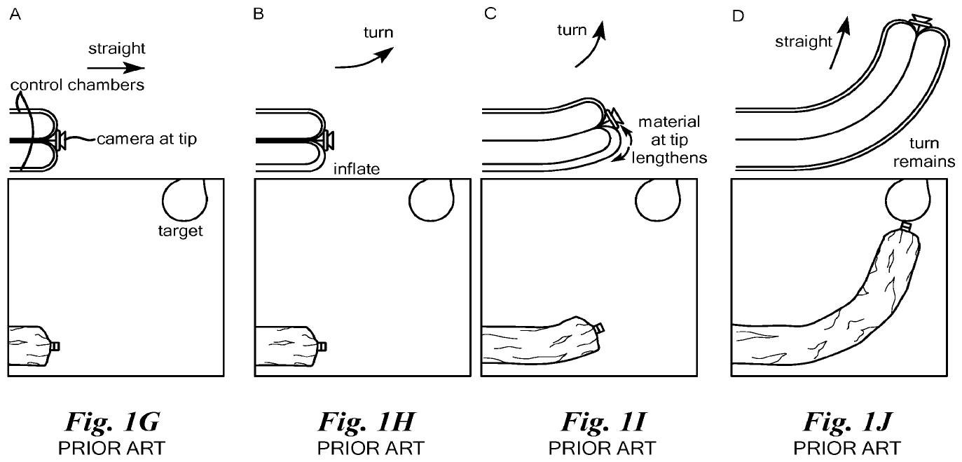

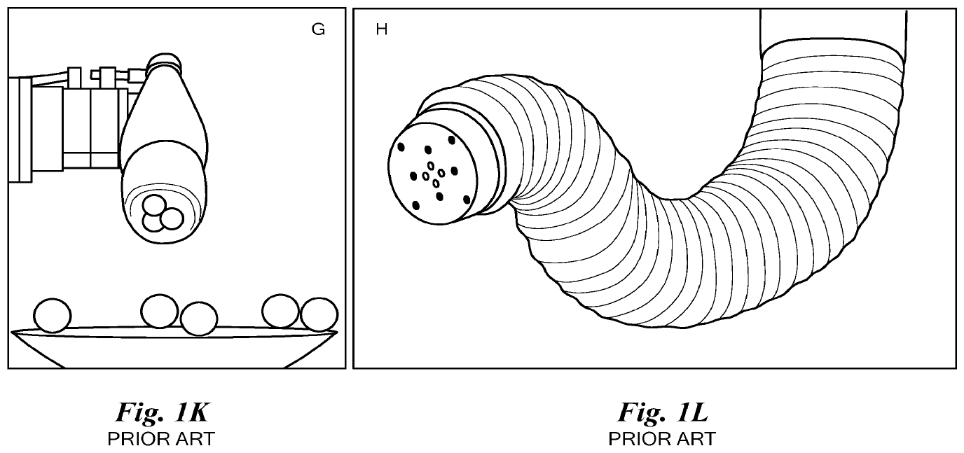

### DETAILED DESCRIPTION OF SPECIFIC EMBODIMENTS

Embodiments of the present invention described herein address the challenges mentioned above by using wireless signals to power up actuators including thermal and pneumatic actuators, and, indeed, any type of thermomechanical actuator. Some of these embodiments generate the required pneumatic pressure inside a McKibben-type artificial muscle or soft robotic grippers without using compressors, pumps, and valves.

Pneumatic artificial muscles have been widely used in industry due to their simple and relatively high-performance design. The emerging field of soft robotics also has been utilizing pneumatic actuation mechanisms to operate. Embodiments of the present invention include mechanisms for actuating pneumatic artificial muscles and soft robotic grippers without the use of compressors, valves, or pressurized gas tanks. The mechanisms in some of these embodiments involve developing pressure inside the muscle via magnetically inducing liquid-to-gas phase transition of a fluid. The volumetric expansion in the liquid-to-gas phase transition develops enough pressure inside the muscle to generate sufficient strain and stress for robotic applications. In some embodiments, this actuation mechanism is integrated into a McKibben-type artificial muscle or a soft robotic arm. The untethered soft robotic arms of some embodiments can lift up an object with the use of only two Li-ion batteries.

In some embodiments, a technique is used so that pneumatic pressure can be generated inside a McKibben-type artificial muscle or soft robotic gripper without compressors, pumps, and valves. The technique involves generating high-pressure gas via inductively heating magnetic materials (e.g., ferromagnetic rod) in a fluid (e.g., water, engineered fluid with a boiling point of 61 degrees Celsius, etc.) with a small and portable high-power induction heater. Induction heating has been already used to heat thermo-sensitive polymers such as poly-N-isoproprylacrylamide (PNIPAAm) doped with magnetic particles (as discussed in T. Shen et al., Remotely triggered locomotion of hydrogel mag-bots in confined spaces, Scientific Reports 7, 16178 (2017); A. H. Mitwalli et al., Closed-Loop Feedback Control of Magnetically-Activated Gels, Journal of intelligent material systems and structures 8.7, 596-604 (1997), each incorporated herein by reference). In these embodiments, the technique is employed to generate pressure for pneumatic actuators. Using this technique, in the fluid's liquid-to-gas phase transition, volume of the fluid can expand by a factor of 1600 at atmospheric pressure, which is among the highest for liquids. By harnessing this large volumetric expansion, strains of up to 20% and work density of 40 kJ/m3, similar to the peak energy density of skeletal muscle (see S. M. Mirvakili et al., Artificial Muscles: Mechanisms, Applications, and Challenges, Adv. Mater. 30, 1704407 (2018), incorporated herein by reference), can be produced with a magnetically induced thermal pneumatic artificial muscle (MITPAM). Moreover, using this technique with an engineered fluid with a boiling point of 61° C., soft robotic grippers can be actuated with the use of only two Lithium-ion batteries.

Other embodiments are based on induction heating of magnetic micro/nano particles within a fluid environment by an alternating magnetic field. For example, an embodiment may generate high pressure steam via inductively heating magnetic nanoparticles mixed with a phase changing fluid, such as water, with a small and portable high-power induction heater. Metallic particles such as ferromagnetic nanoparticles (e.g., Fe₃O₄) generate heat when exposed to a high frequency alternating magnetic field. The physics behind this phenomenon can be produced by different mechanisms such as hysteresis losses, Joule heating via eddy current, Brownian, and Néel relaxation.

### Wireless Actuation System

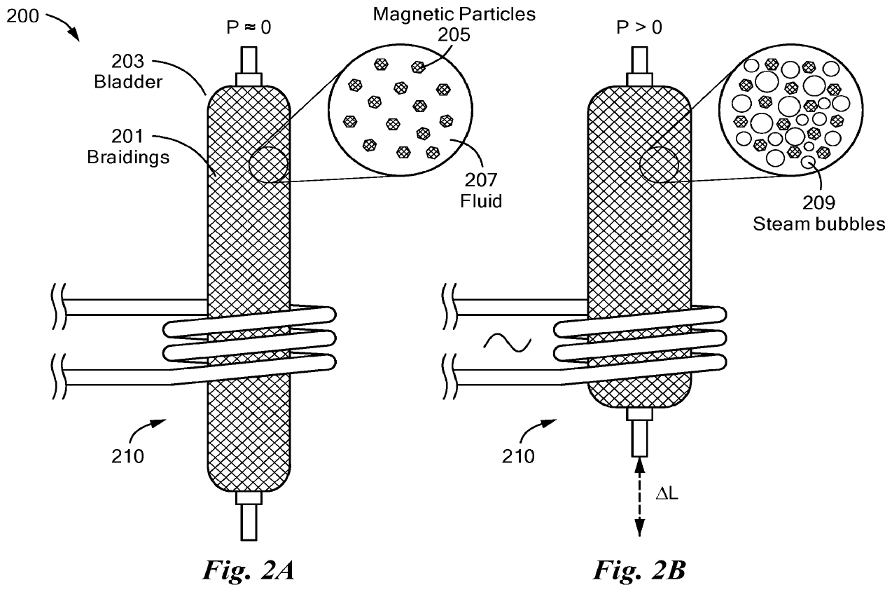

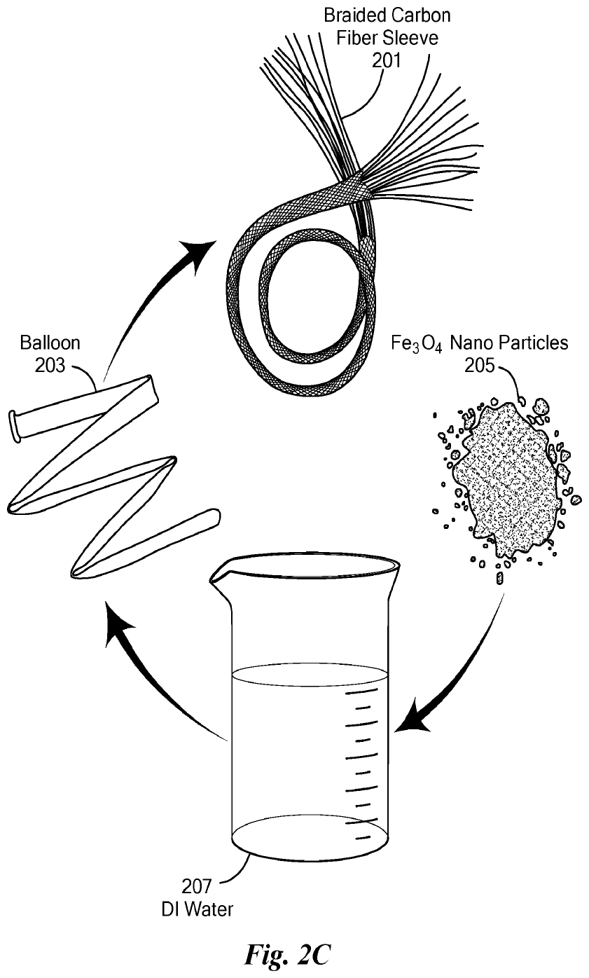

Reference is made to FIGS. 2A-2B, wherein a system 200, in accordance with an embodiment of the present invention, is depicted schematically. In embodiments, the magneto-thermal effect may be used by the system 200 to generate actuation by device 210 (e.g., an embodiment of a pneumatic artificial muscle or actuator).

As shown in FIG. 2A, the device 210 includes a bladder 203. The bladder 203 has an inner surface and an outer surface, the inner surface forming an interior area. The bladder 203 is configured to expand or retract so as to change an area of the interior area. To configure the device 210, the bladder 203 is filled with a dispersion of magnetic particles 205, preferably nanoparticles or microparticles, (e.g., iron, iron oxide, nickel, nickel oxide, cobalt oxide, etc.) suspended in a fluid medium 207, such as a low boiling point liquid (e.g., water, ethanol, etc.), and disposed within the interior area of the bladder 203. In some embodiments, the magnetic particles 205 are coated with a material, for example polymers, such as methoxy-PEG-silane, to prevent any potential agglomeration of the magnetic particles. In the example embodiment, as shown in FIG. 2C, the bladder 203 is a latex balloon, the magnetic particles 205 comprise a magnetite (Fe₃O₄), and the fluid medium 207 is deionized (DI) water. The bladder 203 is then sealed (e.g., knotted). The sealed bladder 203 is inserted into a braided sleeve 201 disposed on the outer surface of the bladder 203, by which the bladder 203 is confined. In the embodiment of FIG. 2C, the braided sleeve 201 is made of carbon fibers. In some embodiments, the braided sleeve 201 may be rolled up on the compliant/stretchable bladder 203. All degrees of softness and compliance of the braided sleeve 201 are included within the scope of the present invention. In other embodiments, the bladder 203, magnetic particles 205, fluid medium 207, and sleeve 201 may be composed of different materials that produce a similar operation.

As shown in FIG. 2B, upon excitation by an alternating, high frequency magnetic field of the system 200, the magnetic particles 205 rise in temperature (heating), which causes a phase transition to the fluid medium 207 within the interior area of the bladder. In the example embodiment of FIG. 2B, the heating of the magnetic particles 205 causes boiling of the fluid medium 207 to generate the phase transition of steam bubbles 209. The phase transition increases a pressure within the bladder 203. Due to the confinement of the bladder 203 within the braided sleeve 201, a volumetric expansion of the bladder 203, caused by the increased pressure, translates to an axial contractile strain and radial expansion of the bladder 203. Such contraction and expansion generate actuation energy or power by the device 210 that is used to move or control a mechanism or system. The bladder 203 retracts back to its original position when the alternating magnetic field is removed causing the magnetic particles 205 and fluid medium 207 to no longer be heated.

In embodiments, the excitation is due to direct or indirect heating of the magnetic particles 205 by the alternating magnetic field. In some embodiments, the magnetic heating is ohmic heating, such that the heating is caused by the magnetic field inducing an electric current (e.g., eddy current) within the device 210. In an embodiment, the heating is caused by the magnetic field generating an electric current within each of the magnetic particles 205 contained in the device 210. In other embodiments, the heating of the magnetic particles 205 is caused by the magnetic field through hysteresis losses, Brownian, and Néel relaxation, and such.

### Method of Wireless Actuation

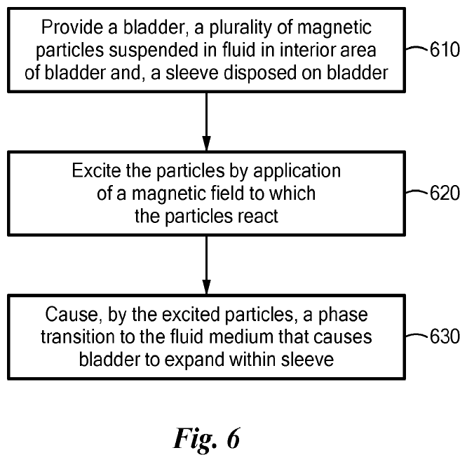

FIG. 6 is a flow chart of generating wireless actuation according to embodiments of the present invention. At step 610, the method of FIG. 6 provides a bladder that has an inner surface and an outer surface, and the inner surface forms an interior area of the bladder. The bladder is configured to expand or retract so as to change an area of the interior area of the bladder. A plurality of magnetic particles are suspended in a fluid medium and disposed within the interior area of the bladder. In some embodiments, the magnetic particles are coated with a material, for example polymers, such as methoxy-PEG-silane, to prevent any potential agglomeration of the magnetic particles. A braided sleeve is disposed on the outer surface of the bladder. In some embodiments, the bladder is made of latex material (e.g., a latex balloon). In some embodiments, the magnetic particles are microparticles or nanoparticles. In an embodiment, the magnetic particles are nanoparticles between 200 nm and 300 nm in diameter. In some embodiments, the magnetic particles comprise one or more of: iron, iron oxide, nickel, nickel oxide, cobalt and/or cobalt oxide. In an embodiment, the magnetic particles comprise Fe₃O₄. In some embodiments, the fluid is a low boiling point liquid, such as DI water, carbonated water, ethanol, etc. In some embodiments, the sleeve is made of braided carbon fiber.

At step 620, the method excites the magnetic particles by application of an alternating magnetic field which interacts with the magnetic particles. In some embodiments, the magnetic field is a high frequency alternating magnetic field. In some embodiments, the excitement of the magnetic particles includes heating of the particles within the interior area of the bladder due to the interaction with the alternating magnetic field. In some embodiments, the magnetic particles are excited by the alternating magnetic field inducing a current (e.g., an eddy current) within a set of the magnetic particles. In some embodiments, the magnetic particles are excited by the magnetic field causing hysteresis losses, Brownian relaxation, and/or Néel relaxation.

At step 630, the method causes, by the excited magnetic particles, a phase transition to the fluid within the interior area of the bladder which causes the bladder to expand, such that the sleeve confining the bladder generates actuation from the expansion or retraction of the bladder. In some embodiments, where the excitement includes heating, the heated particles cause the phase transition to the fluid within the interior area of the bladder. In some of these embodiments, the phase transition includes generating steam within the interior area of the bladder by the heated magnetic particles boiling the fluid within the interior area, such that the steam causes the bladder to expand within the sleeve. In some of these embodiments, the bladder is expanded due to pressure caused by the steam, and due to confinement of the bladder within the braided sleeve, the expansion or retraction of the bladder causes actuation. The expansion may include axial contractile strain, radial expansion, rotation, etc. of the bladder that generates the actuation. The actuation produces power or energy that may be used to move or control a mechanism or system, such as a robot arm.

Embodiments of the device 210 may be used in thermal actuators such as nylon actuator, shape memory alloys, shape memory polymers, and shape memory materials in general. The magnetic particles 205 may be dispersed in a liquid adhesive and coated on the actuator body to generate the heat required for excitation. For paraffin wax-infiltrated actuators, the magnetic particles 205 may be mixed with paraffin or any other thermo-responsive material with good volumetric expansion and infiltrate the yarn with it. Bending, linear, and torsional actuators made with nylon and shape memory alloys may be used.

Wireless Actuation System with Induction Coil and Heater

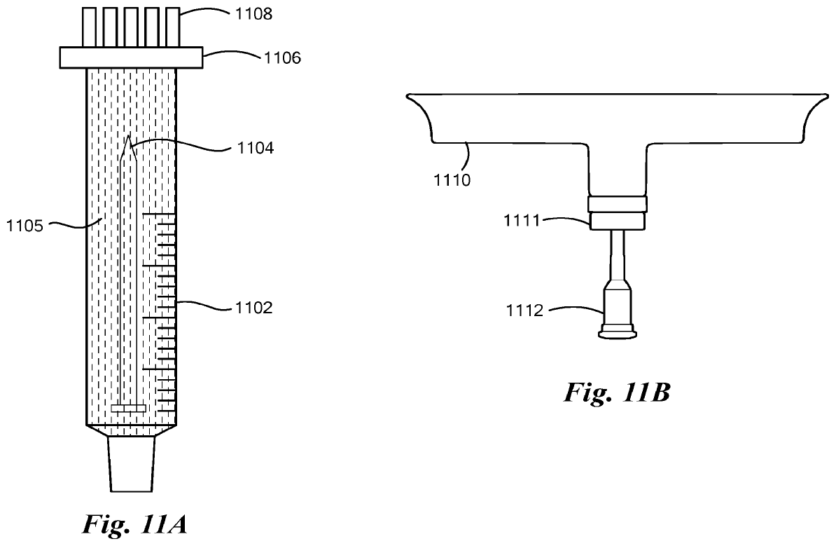

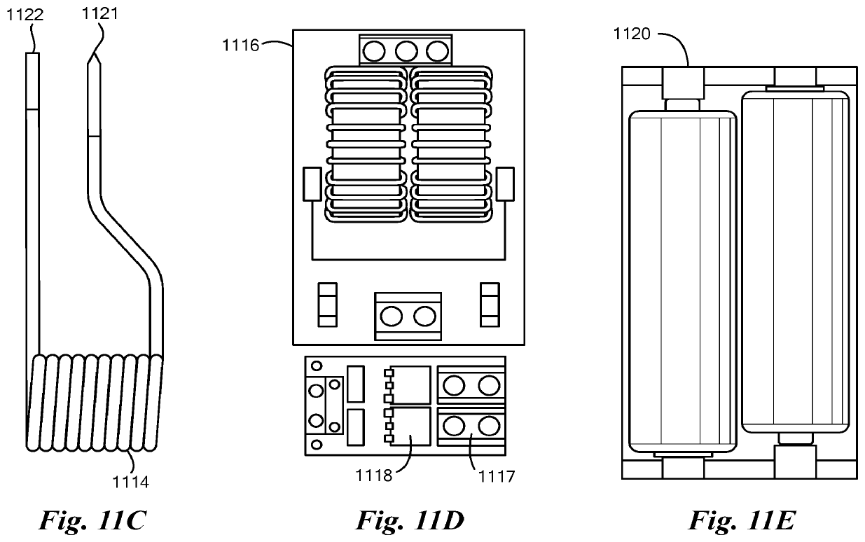

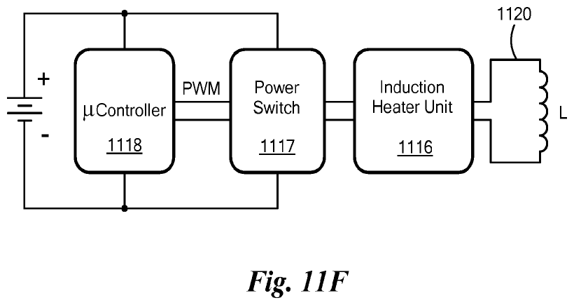

Reference is made to FIGS. 11A-11F, which schematically depict another system (device) for wireless actuation, in accordance with embodiments of the present invention.

As shown in FIG. 11A, the device includes a sealed container 1102. In some embodiments, the container 1102 is made of a non-ferromagnetic material. In the embodiment of FIG. 11A, the container 1102 is a 2 mL glass syringe that is sealed with a metallic (e.g., copper) plate 1106 coupled to a heat sink 1108.

The container 1102 houses a magnetic rod 1104 suspended in fluid 1105. In some embodiments, the magnetic rod 1104 is a ferromagnetic rod. In the embodiment of FIG. 11A, the magnetic rod 1104 is an iron nail. In some embodiments, the fluid 1105 is an engineered fluid with a boiling point of 61° Celsius. The magnetic rod 1104 is configured to interact with a magnetic field and cause, based on the interaction, a phase transition of the fluid 1105 within the container 1102. In some embodiments, the magnetic rod 1104 is configured to increase in temperature based on the interaction with the magnetic field and the increased temperature of the magnetic rod 1104 causes the phase transition of the fluid 1105.

As shown in FIG. 11B, the device also includes a bladder 1110. The bladder 1110 has an outer surface and an inner surface that forms an interior area. The bladder 1110 is configured to expand or retract so as to change an area of the interior area. In some embodiments, the bladder 1110 is made of silicone rubber. In some embodiments, the bladder 1110 is a compliant bladder. In some embodiments, the bladder 1110 is a soft robot that operates using pneumatic or hydraulic pressure. In the embodiment of FIG. 11B, the bladder 1110 is a soft robotic gripper.

The bladder 1110 is fluidly coupled to the container 1102 via a connector 1112. To provide the coupling, the connector 1112 is attached at its first end to the bladder 1110 and at its second end to the container 1102. In the embodiment of FIG. 11B, the connector 1112 is a dispensing needle (e.g., gauge 14) that is inserted, at its first end, into a portion 1111 of the bladder 1110 and attached, at its second end, to the metallic seal 1106 of the container 1102. In some embodiments, the phase transition of the fluid 1105 includes gas generated within the container 1102 due to the magnetic rod 1104 interacting with a magnetic field, such that the gas is transferred to the interior area of the bladder 1110, via the connector 1112, and causes the bladder 1110 to expand so as to operate the bladder 1110 (e.g., robotic gripper). The phase transition of the fluid 1105 causes the bladder 1110 to expand due to pressure caused by the gas within the interior area of the bladder 1110.

As shown in FIG. 11C, the device further includes an induction coil 1114. In some embodiments, the induction coil 1114 has an inner diameter of 17 mm. A first end 1121 of the induction coil 1114 is coupled to the interior of the container 1102. In some embodiments, the induction coil 1114 is disposed around the container 1102. As shown in FIG. 11D, the device also includes an induction heater unit 1116, which couples to a second end 1122 of the induction coil 1114. The induction heater unit 1116 powers the coupled induction coil 1114, such that the induction coil 1114 generates a magnetic field within the interior of the container 1102. FIG. 11C also shows an electronic controller 1118 that is in communication, via a power switch (switch control) 1117, with the induction heater 1116. The controller 1118 is configured to control the voltage provided to the induction coil 1114 from the induction heater unit 1116. As shown in FIG. 11E, the device is powered by batteries 1120, such as a pair of 4 V Lithium-ion batteries (e.g., 3000 mAh).

FIG. 11F is a circuit diagram showing the configuration of the device's electronic components (controller 1118, power switch 1117, induction heater unit 1116, and batteries 1120) in embodiments of the present invention.

### Method of Wireless Actuation Using Induction Coil and Heater

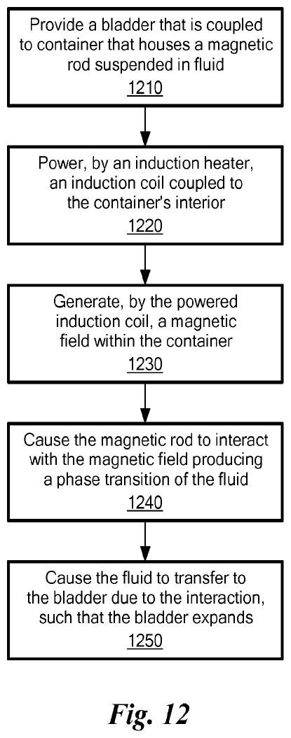

FIG. 12 is a flow chart of generating wireless actuation of a device according to embodiments of the present invention.

At step 1210, the method of FIG. 12 provides a bladder that is fluidly coupled to a container that houses a magnetic rod suspended in a fluid medium (fluid). The bladder has an outer surface and an inner surface that forms an interior area. The bladder is configured to expand or retract so as to change an area of the interior area. In some embodiments, the bladder is made of silicone rubber and/or is a compliant bladder. In some embodiments, the bladder is a robotic gripper or a soft robot that operates using pneumatic or hydraulic pressure.

In some embodiments, the container is a glass syringe and/or made of a non-ferromagnetic material. In some embodiments, the container is sealed with a metallic plate, which may be coupled to a heat sink. In some embodiments, the fluid medium in the container is an engineered fluid with a boiling point of 61° Celsius. The bladder is fluidly coupled to the container via a connector, such as a dispensing needle.

At step 1220, the method powers, by an induction heater, an induction coil coupled to the container's interior. The induction coil is coupled at a first end to the container's interior and at a second end to the induction heater. In some embodiment, the induction coil is disposed around the container. In some embodiments, a controller, in communication with the induction heater via a power switch, is configured to control the voltage provided to the induction coil from the induction heater. In some embodiments, the induction heater components are powered by batteries (e.g., Li-ion batteries).

At step 1230, the method generates, by the powered induction coil, a magnetic field within the container. At step 1240, the method causes the magnetic rod to interact with the magnetic field, producing a phase transition of the fluid medium within the container. In some embodiments, the magnetic rod is configured to increase in temperature due to the interaction with the magnetic field and the increased temperature of the magnetic rod causes the phase transition of the fluid medium.

At step 1250, the method causes, due to the interaction, the fluid medium to transfer from the container, via the connector, to the interior of the bladder, such that the bladder expands in a manner that operates the device. In some embodiments, the phase transition of the fluid medium includes generation of gas within the container due to the interaction with the magnetic rod, such that the gas is transferred to the interior area of the bladder, via the connector, and causes the bladder to expand. In some embodiments, the phase transition of the fluid medium causes the bladder to expand due to pressure from the gas within the interior area of the bladder.

### Applications

Pneumatic artificial muscles have been applied in biomedical devices such as prosthetic arms/legs, robotic arms, robotic grippers, and even 3D printers. Classic pneumatic linear actuators made from movable discrete components such as pistons moving within cylinders, can generate relatively high strain rates and are typically used in industries requiring rapid manufacturing throughput. Due to the untethered nature of the actuation mechanism, the actuator can potentially be used in a confined environment in which a mechanical work is required. Examples can be in vacuum or cryogenic environments.

Another confined environment can be the human body. In balloon angioplasty, an endovascular procedure to widen narrowed or obstructed arteries or veins (typically to treat arterial atherosclerosis), a balloon is pressurized from outside the body. By utilizing techniques in accordance with the present invention, there is no need to have a long tube. Moreover, instead of one balloon at a time, multiple balloons can be used at different locations without the need for a tube.

One of the major advantages of techniques described herein in accordance with embodiments of the present invention is that unlike electromagnetic waves, the magnetic field may be localized and can be used to locally active actuators without activating the neighbouring ones. Some approaches are offered by harvesting EM waves and using them to charge a capacitor and use the charge in the capacitor to power up a micro-device. The problem associated with this technique is that the device can be hacked by and EM waves can scatter in different environments in different directions.

Fabrication methods, such as molding and 3D printing, have been used to fabricate PAMs that can generate bending and/or torsional actuation in addition to linear actuation. The techniques in embodiments of the present invention use heat converting units, such as magnetic nano/micro particles combined with phase transition materials, to achieve pressure inside a confined system. This pressure can be utilized in any actuator (that works on the basis of pressure or phase transition of a material) fabricated via additive manufacturing (e.g., 3D printing), molding, and other such manufacturing techniques.

### EXAMPLE I

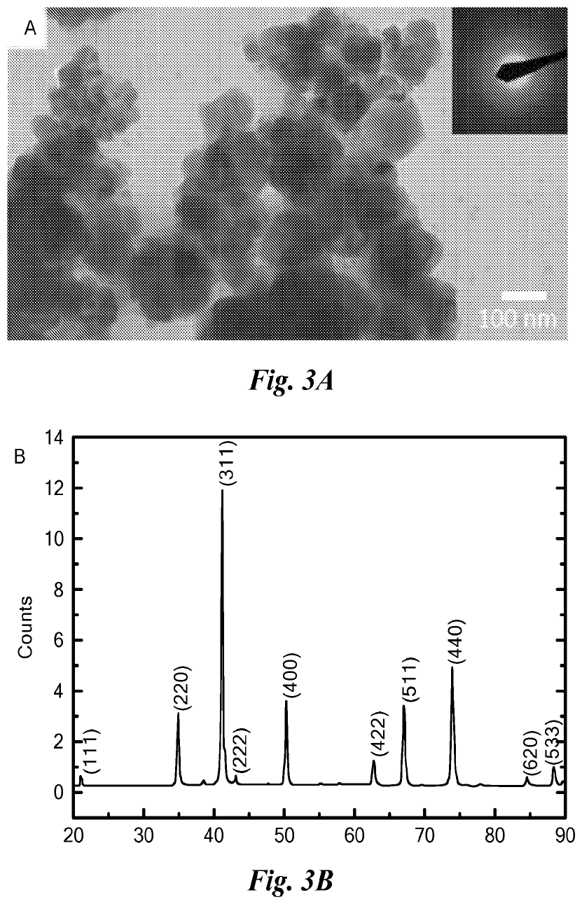

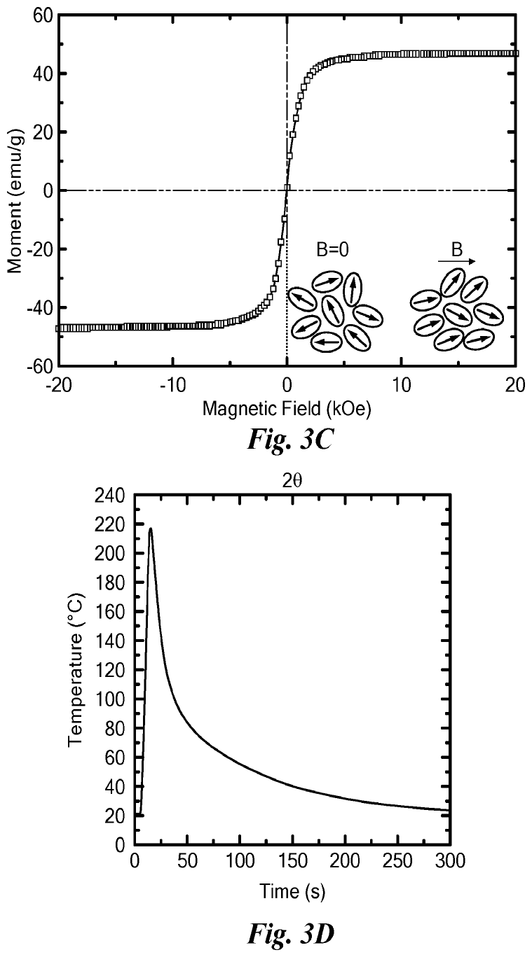

A wireless actuation device, such as shown in FIGS. 2A and 2B, was made from commercially available iron oxide-based magnetic nanoparticles. The magnetic nanoparticles had a particle size diameter that ranged between 200 nanometer (nm)-300 nm, as shown by the scanning electronic microscope (SEM) image in FIG. 3A. The magnetic nanoparticles were made of magnetite (Fe₃O₄), as shown by the graph of X-ray powder diffraction (XRD) patterns of the sample in FIG. 3B. The magnetic nanoparticles provide the energy converting units. Therefore, the more efficient the magnetic nanoparticles convert the alternating magnetic field to heat, the less input electric power is needed which enhances the over efficiency of the wireless actuation device. Magnetization plays an important role in determining the heat generation rate. At a DC magnetization magnetic moment of 47 emu/g, a temperature increasing rate of 20° C./s was measured for a 197 mg sample with the wireless actuation device excited with a magnetic field generated by an input power of 900 W at 224 kHz. FIG. 3C shows a graph of the DC magnetization moment of input power as a function of the magnetic field. FIG. 3D shows a graph of the increasing rate of the temperature (temperature as a function of time). This relatively large temperature increasing rate enabled achievement of higher strain rates. In fact, the strain rate was measured at 1.2%/s, which is higher than that of any phase changing-based materials McKibben muscle (<<1%/s).

Due to the high surface to volume ratio of the magnetic nanoparticles used, a higher rate of generating steam was achieved compared to the case of using a wire coiled inside the system to generate steam. This increase in steam generation was due to the fact that heating of the magnetic nanoparticles—water dispersion occurs almost simultaneously, whereas for the case of using a coiled wire, part of the heat should be transferred via convection or conduction in the phase-changing material. More importantly, using a solid wire as a heating element added to the stiffness of the actuator which in return decreased the contractile strain. Moreover, encapsulation of the system for high pressure conditions was much easier without implementing a heating wire that passes through the structure.

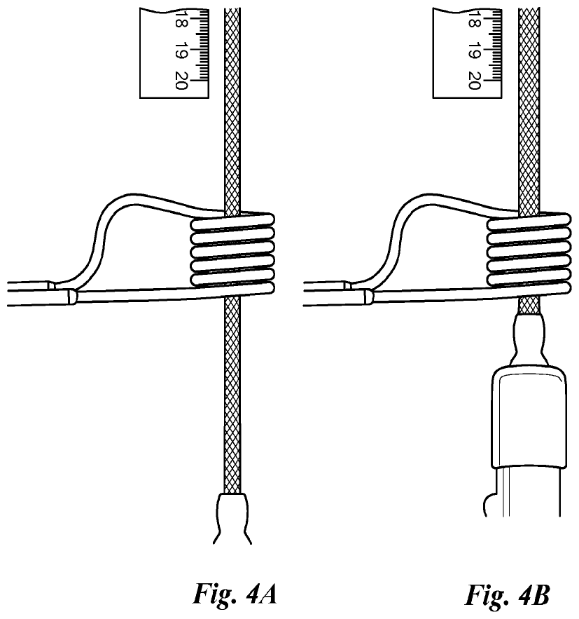

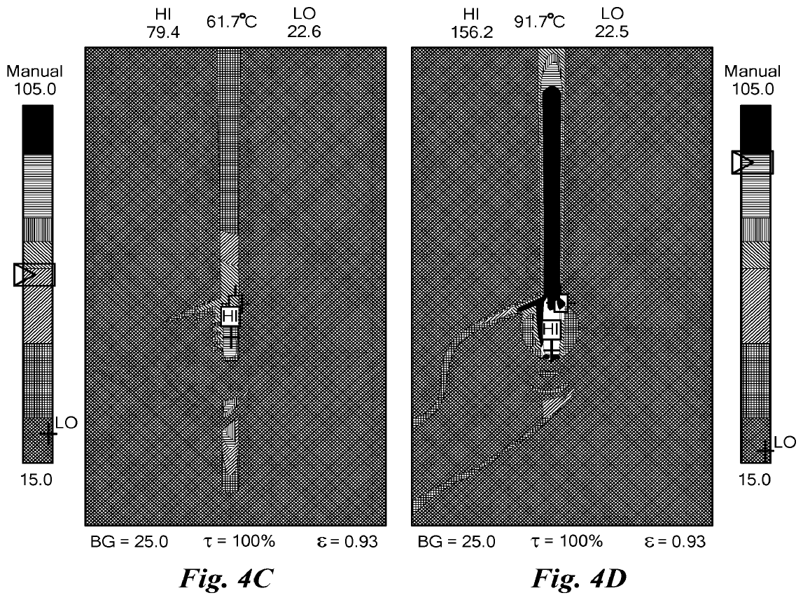

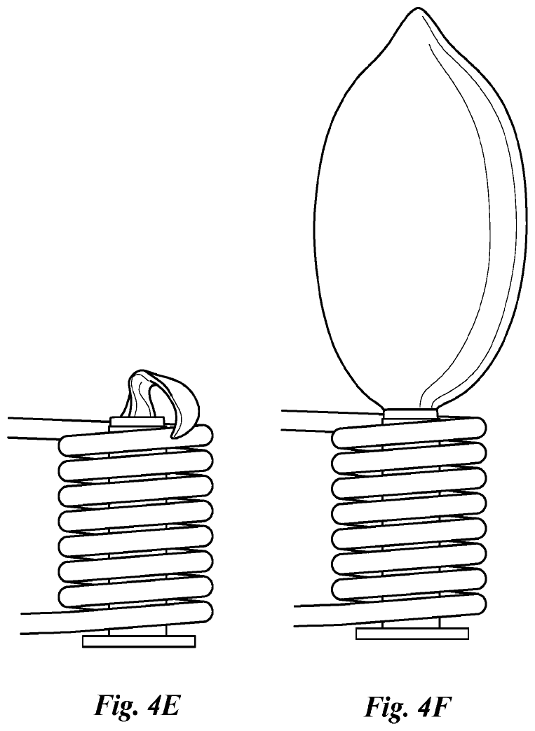

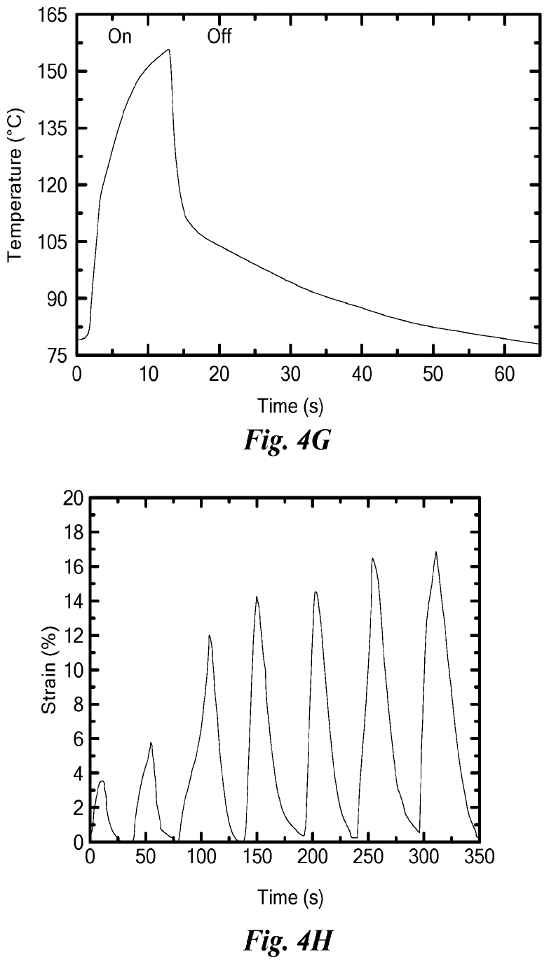

The wireless activation device made according to this example achieved 20% contractile strain under 2 kg of load, which is very comparable to what can be achieved with a high-pressure air McKibben artificial muscle. FIGS. 4A and 4B illustrate the wireless activation device under a load of 2k before excitation (FIG. 4A), and the device under the 2k load after excitation (FIG. 4B). Temperature measurements with a thermal camera and a fiber optic temperature measurement module revealed that the temperature inside the bladder exceeded 120° C. (as shown in FIGS. 4C-4D and 4I). FIGS. 4C and 4D illustrate temperature measurement of a sample actuation cycle of the device before excitation (FIG. 4C) by using a thermal camera and after excitation (FIG. 4D) using the thermal camera. FIG. 4I shows the temperature and block profiles for a sample under isometric conditions.

To demonstrate the generation of steam pressure inside the bladder, a glass vial was filled with magnetic nanoparticles/water dispersion and sealed within the latex balloon. When excited by a magnetic field, the dispersion generated enough pressure to expand the balloon. FIGS. 4E and 4F illustrate the excitation of the balloon filled with the magnetic nanoparticles/water dispersion illustrating the pressure generated inside the balloon (bladder) during the excitation. These figures show the balloon before excitation (FIG. 4E) and after excitation (FIG. 4F). A pressure measured at 2.1 kPa±0.44 kPa was required to inflate the same type of balloon to a similar volume that was inflated with the magneto-thermal excitation. The cooling time of the device in the relaxation state was on the order of 10 s of seconds, as shown by the graph of FIG. 4G which plots the temperature profile of the sample during on-off cycles. The cooling time can be a rate limiting factor, however, it was observed to allow achievement of a higher strain rates in successive excitations. FIG. 4H shows a graph of a strain curve for multiple cycles of excitation of the device. The first cycles show the device still warming up, while the last cycles show the device having reached a steady state peak strain. As FIG. 4G suggests, the cooling (temperature) profile of the magnetic nanoparticles sample consisted of two cooling regions in the “off” state. In the first region, happening right after the power was switched off to the device (actuator), the drop in strain was large and fast. This fast drop in temperature and strain allowed the device to relax to its natural state faster while its temperature was still above the room temperature. This temperature gap can be harnessed in the next excitation cycle to save some heating time. To better evaluate the performance of the device (muscle), the block force (Fblock) was measured under isometric conditions. The measurement showed that the block force profile is very similar to that of the temperature profile which makes controlling the output force easier for robotic applications. FIG. 4I illustrates graphs of the temperature and block force profiles for a sample under isometric conditions.

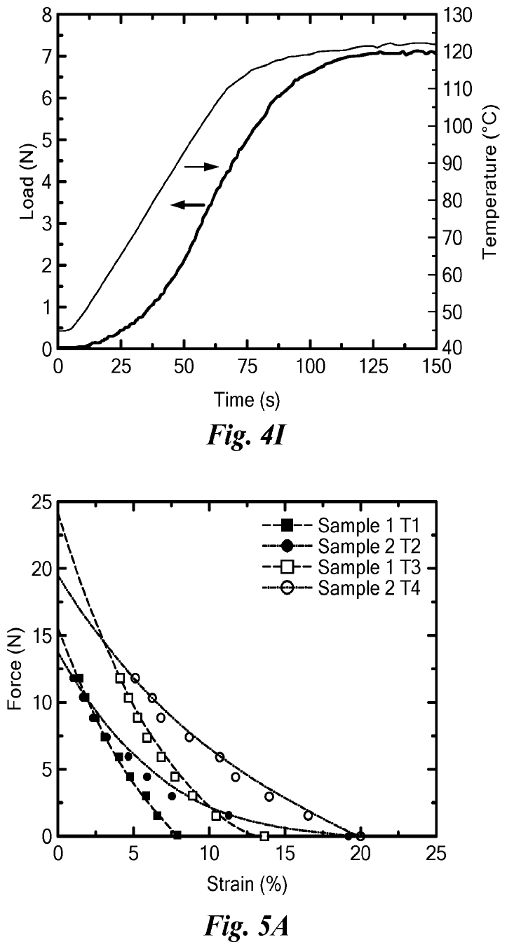

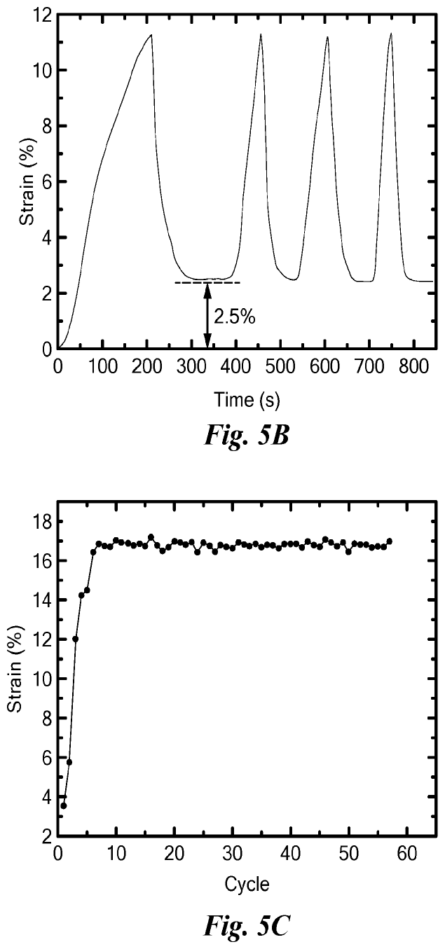

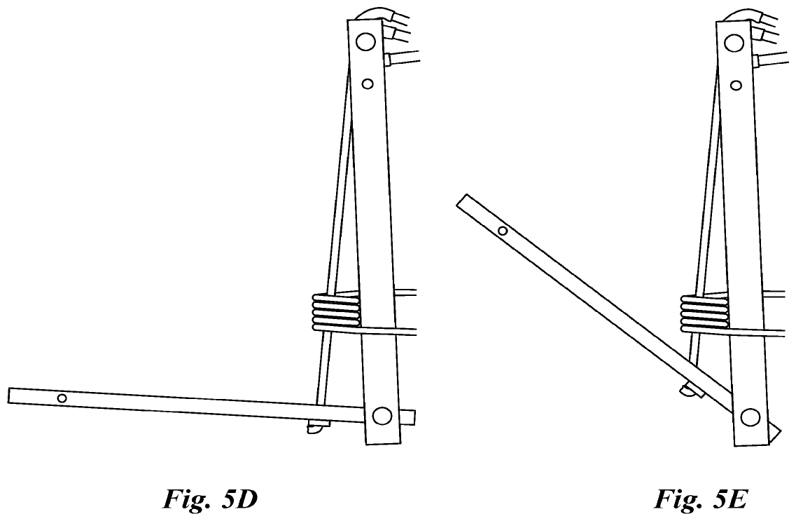

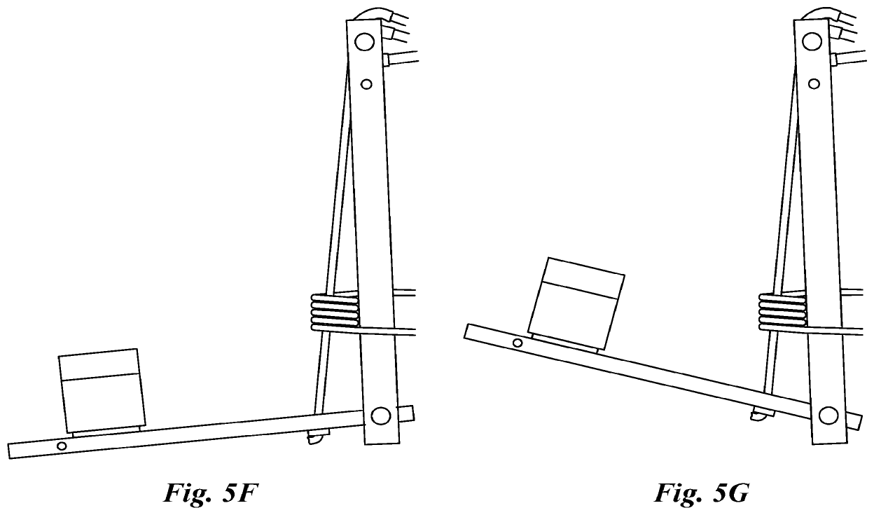

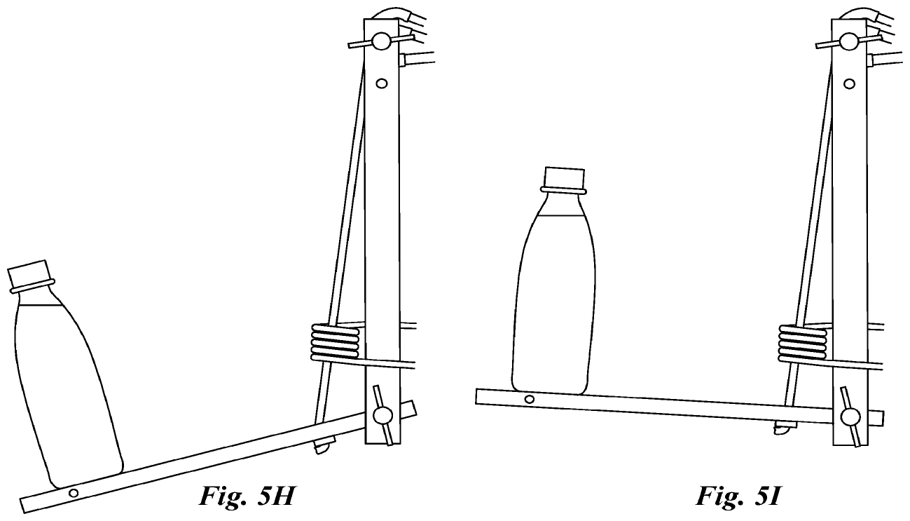

To better understand the working mechanism of the device , a model was developed which used temperature (T) and strain (ε) to predict the output force from the following equation (A):

$$F ( T , ϵ ) = ( π {r}_{o}^{2} ) [ γ ( T - {T}_{o} ) - \frac{1}{k} ln ( b ( 1 - ϵ ) - \frac{a}{3} {( 1 - ϵ )}^{3} ) ] [ {a ( 1 - ϵ )}^{2} - b ] \qquad ( A )$$

where ro is the initial radius of the muscle, a and b are function of the initial bias angle of the braiding (θo), and γ and κ are thermal pressure coefficient and coefficient of compressibility, respectively. To evaluate this model, two samples were made with different initial bias angles and dispersion concentrations. Sample 1, with initial bias angle of 34.8° and dispersion concentration of 0.2 g/mL generated less strain at zero load, while sample 2, with bias angle of 40° and dispersion concentration of 0.1 g/mL, generated larger strain at zero load and smaller force at zero strain. The model was fitted with experimental data by measuring the T, To, θo, γ, and κ experimentally. FIG. 5A shows a graph of the force (pressure) within the device as a function of percentage strain of the device using this model and experimental data for the two samples excited at two different temperatures.

For some robotic applications, such as in robotic surgery, it is desirable to lock the muscle after the first excitation without consuming further power. In nature, this happens to spider dragline silk. At high humidity conditions such as raining, the dragline silk super contracts (50% strain under no load) and maintains it. To obtain such a property, instead of using water, carbonated water was used to make the dispersion. The results show strain locking of 2.5% which is 22% of the active strain. FIG. 5B shows a graph that illustrates locking strain or locking contraction after the first cycle of the excitation with the dispersion made with carbonated water.

To evaluate reproducibility of the strain, the muscle was excited 50 more cycles after it reached a stable strain response and no significant degradation in the strain was observed. FIG. 5C shows a graph of the peak strain evolution through 50 successive excitation cycles. Considering the combination of strain and stress that the device can generate, it can be a good candidate for robotic applications. As a demonstration, a robotic arm was made and connected the device in a similar configuration to how the human biceps are connected to the elbow. Performance of the device was tested under no load, 250 g, and 500 g load. FIGS. 5D-5I demonstrates using the device for the robotic arm before (FIG. 5D) and after (FIG. 5E) excitation without any load, before (FIG. 5F) and after (FIG. 5G) excitation with the 250 g load, and before (FIG. 5H) and after (FIG. 5I) excitation with the 500 g load. The results indicate that the device can indeed be used for untethered robotic applications.

### EXAMPLE II

### Material and Heating Mechanism

In this example, a concentration of 1-2 g iron oxide was dispersed in 7-10 mL of water and placed within a sealed bladder (muscle) and exposed to an alternating magnetic field.

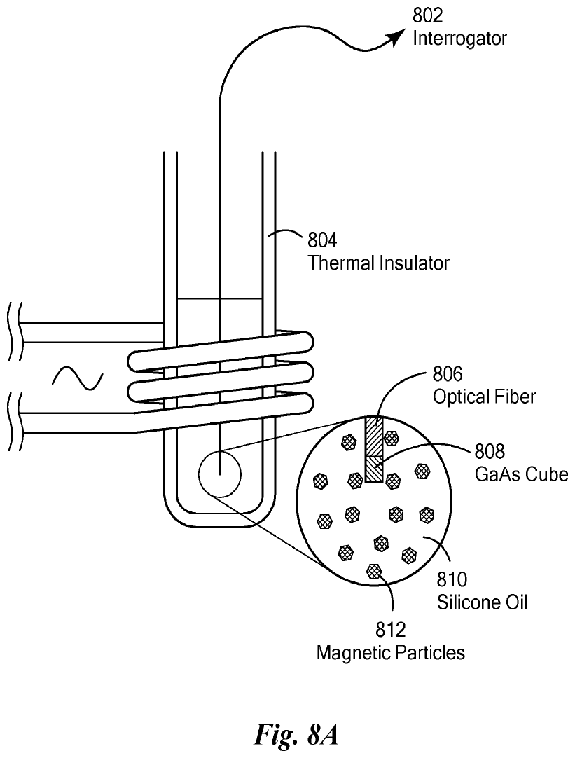

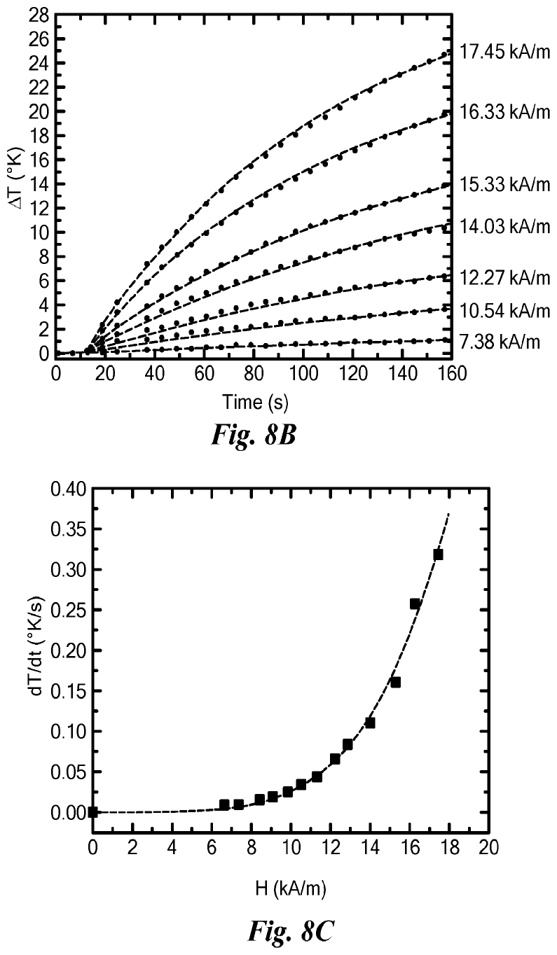

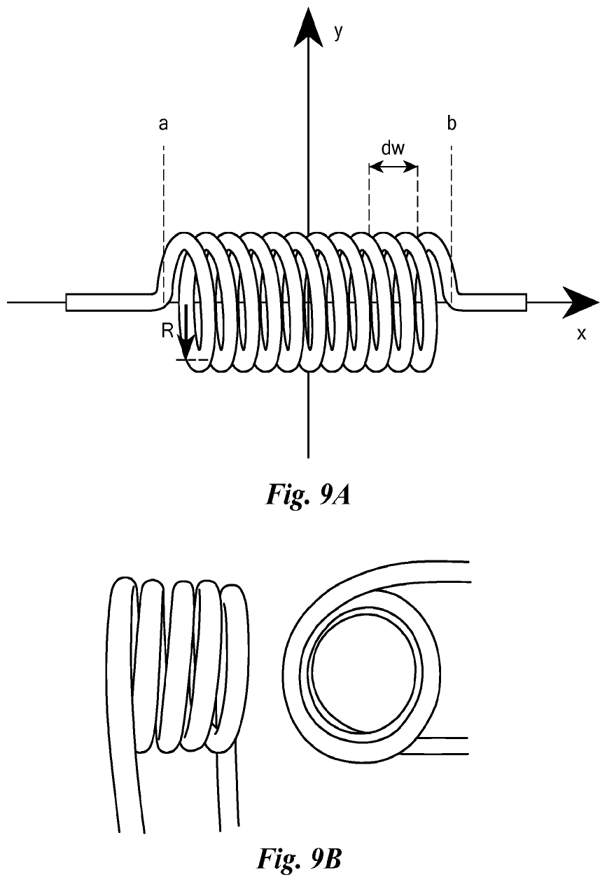

Upon exposure to an alternating magnetic field, metals (with grain size of greater than 1 μm) generate heat due to formation of an eddy current. This induced current in the metallic piece generates a Joule heating effect. The distribution of the induced current inside the conductor is dictated by the skin depth which itself is a function of the frequency (ƒ), electrical conductivity (σ) and magnetic permeability (μ) of the material (i.e., δ=1/\sqrt{πƒσμ.} The effective heating power (per mass) due to an eddy current for a polydispersion system with grain diameter mean square of <d²> equals:

$$〈 {P}_{e} 〉 = \frac{{( {πμ}_{σ} fH )}^{2}}{20 {ρ}_{e} {ρ}_{m}} 〈 {d}^{2} 〉 \qquad ( 1 )$$

where pₑ is the electrical resistivity of the metallic particles, pₘ is the volumetric mass density of the sample, ƒ is the magnetic oscillation frequency, H is the magnetic field strength, μ₀ is the vacuum magnetic permeability (μ₀=4π×10−⁷ H/m). The mean square of the grain diameter is <d²>=d₀² exp(2β²) where d₀ and β are parameters of the lognormal function. In this form of induction of heating, the sample can be treated as an RL circuit where the L represents inductance of the secondary winding of a transformer with the primary winding being the induction heating coil and R represents the Joule heating effect (as shown in FIG. 8C).

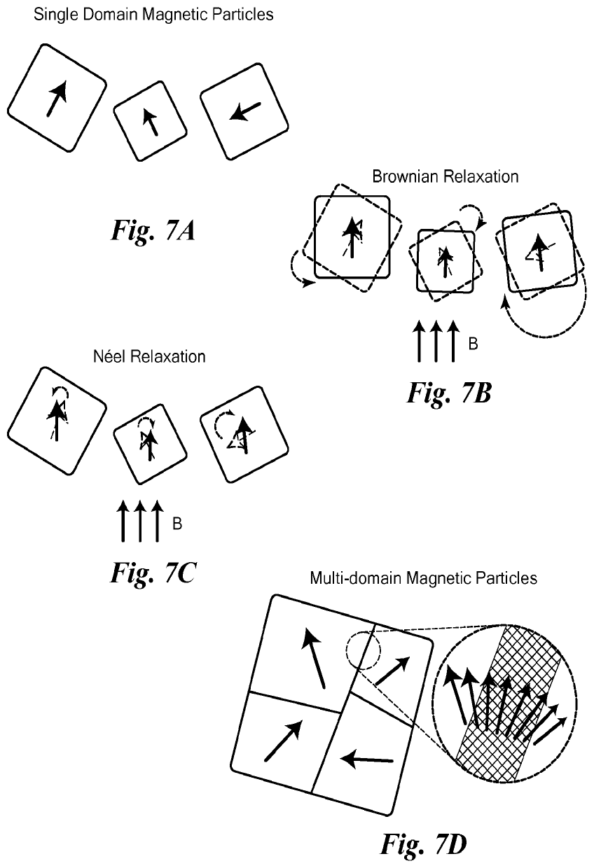

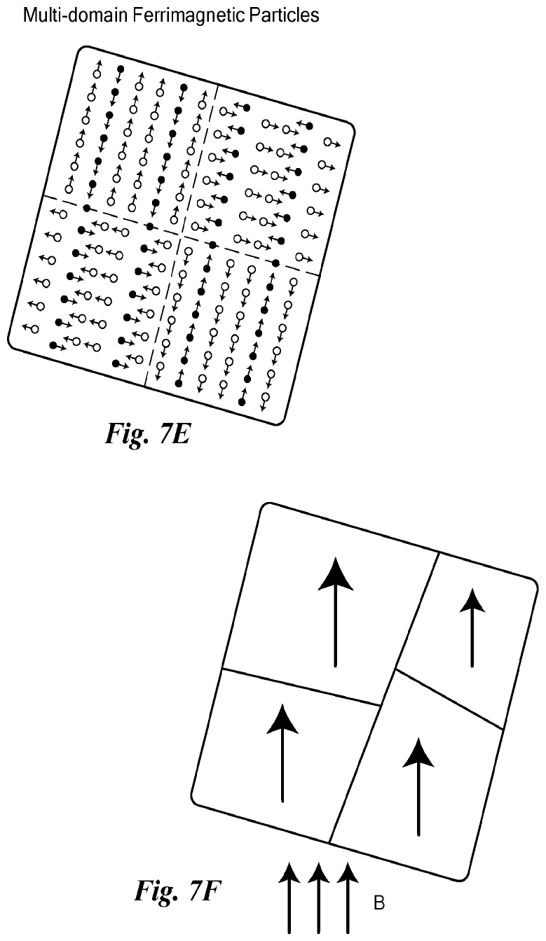

For magnetic nano-particles, such as ferrimagnetic materials, (e.g., Fe₃O₄) dispersed in a liquid, Brownian-Néel relaxation (for single domain particles such as superparamagnetic nano-particles) and hysteresis losses (for multi-magnetic domains) are the dominant heating mechanisms, as shown in FIGS. 7A-7F. FIG. 7A shows single domain magnetic particles, such as superparamagnetic nano-particles, which are typically 5 nm to 10 nm in size. FIG. 7B shows that under a magnetic field, the magnetic nano-particles physically rotate to facilitate the Brownian relaxation. FIG. 7C shows that in Néel relaxation, the magnetic moment of the nano-particles is rapidly aligned within the domain under an external magnetic field. FIG. 7D shows multi-domain magnetic nano-particles which are usually larger than 100 nm in size. The inset in FIG. 7D shows how the magnetic moment transforms from one domain to another. FIG. 7E shows multi-domain ferromagnetic particles, such as Fe₃C>₄. The red and blue circles represent the tetrahedral (occupied by Fe³⁺) and octahedral (occupied by both Fe³⁺ and Fe²⁺) sub-lattices in the crystal structure, respectively. FIG. 7F shows application of a magnetic field aligns the magnetic domains inside the nano-material.

In order to achieve heat generation by the magnetic nano-particles, the period of magnetic field oscillation should be shorter than the Brownian relaxation time (τ_{B}), Néel relaxation time (τ_{N}), and the overall effective relaxation time, which is τ=(1/τ_{B}+l/τ_{N})⁻¹, if both mechanisms are desired. In Brownian relaxation (as shown in FIG. 7B), the nano-particles rotate to align with the applied magnetic field, however, in Néel relaxation (as shown in FIG. 7C) the magnetic moment inside the particle align itself with the applied magnetic field. For multi-domain magnetic particles (as shown in FIG. 7D), the domains are aligned in different directions. However, across the magnetic domain walls magnetization direction gradually aligns with the magnetization of the neighboring domain (FIG. 7D). In multi-domain magnetic particles, when exposed to an oscillating magnetic field, the domain walls jump over the voids and imperfections (known as Barkhausen jumps) and generate the hysteresis heating. Heating power density (a.k.a., Specific Absorption Rate (SAR) and Specific Loss Power (SLP)) in hysteresis heating is proportional to area of the hysteresis in the magnetization (M) vs magnetic field (H) curve and the frequency (ƒ) as the following equation suggests:

$${P}_{h} = \frac{f {μ}_{o}}{{ρ}_{m}} ∮ MdH \qquad ( 2 )$$

It is observed that particles that exhibit ferromagnetic behavior (i.e., hysteresis), at low magnetic fields (below 5 kA/m or 63 Oe), the Pₕ scales with H³. This third-order power law is in distinction with the second-order power law for the power scaling with magnetic field in eddy current induction heating mechanism. The magnitude of the generated heat due to hysteresis is proportional to the frequency (∝ƒ), while for eddy current, it is proportional to the square of the frequency (∝ƒ²). The frequency ƒ≈150 kHz was chosen which provides enough heat for exciting the pneumatic actuator and is easy to generate with high power metal oxide semiconductor field effects (MOSFETs) in a compact circuit.

### EXAMPLE III

Considering the size of the nanoparticles used in Example I (i.e., 00 nm-300 nm), it is hypothesized that hysteresis loss is the dominant heating mechanism. To test this hypothesis, the behavior of heating power was examined as a function of magnetic field. FIG. 8A illustrates the apparatus that was used to measure and characterize the magnetic nanoparticles to examination this behavior. The apparatus included a thermal insulator 804, interrogator 802, optical fiber 806, and gas cube 808, and contained a solution of magnetic nanoparticles 812 mixed in silicone oil 810. FIG. 8B shows a graph of the temperature profile of the magnetic nanoparticles 812 in the silicone oil 810 excited at different magnetic field intensities within the apparatus. FIG. 8C shows a graph of the initial rate of temperature increase as a function of excited magnetic field intensity in the apparatus. Square dots and the dashed-line represent the measure data and fitted model, respectively.

For this Example, the sample was prepared by mixing 1.134 g of the magnetic nanoparticles 812 with 11.25 mL silicone oil 810. For the experiment, 0.6 mL of the resulting solution was transferred to a 1 mL vial and the sample was then placed inside a bigger vial. The gap between the two vials was filled with a thermally insulating material 804 (aerogel). The coil temperature was kept constant at 17° C. during the experiment by running a constant temperature water through the coil (as shown in FIG. 8A). The magnetic field was varied from 7.38 kA/m to 17.45 kA/m at constant frequency of 148 kHz. The power balance equation can be written as:

$$\vert P = C \frac{dT}{dt} + L ( T ( t ) - {T}_{o} ) \qquad ( 3 A )$$

where Tₒ is the ambient temperature, C is the heat capacity (J/K), and L is the heat loss coefficient (W/K). Eq. 3A can be solved analytically in form of:

T(t)=Tₒ+ΔT_{∞}(1−exp(−t/τ)) (3B)

where ΔT_{∞}=P/L and τ=C/L. The measured profiles (from 11 s to 160 s) were fitted with an exponential function in form of:

T(t)=T_{∞}(1−exp(−t/τ)) (3C)

where T∞ is the temperature difference between the vial and the ambient at steady state and τ is the heating time constant. The rate of increase in temperature right after the excitation can be expressed as:

$${( \frac{dT}{dt} )}_{t = 0} = \frac{{T}_{∞}}{τ} \qquad ( 4 )$$

The (dT/dt)ₜ=o for each temperature profile is plotted as a function of the excited magnetic field and fitted with (H/a)ⁿ (as shown in FIG. 8C). From the fit, n was found to be 4.63 with a=22.3. The value of n, which is greater than 2, suggests that hysteresis loss is the dominant heating mechanism.

The induction heating apparatus used in Example III was based on a Zero Voltage Switching (ZVS) topology. In this circuit (as shown in FIG. 8C), soft switching was used to reduce the voltage/current stress on the MOSFET during on/off transitions by employing a MOSFET that has a fast-body diode across its drain and source. The magnetic nano-particles are represented as a LC circuit in the circuit diagram with R and L representing a heating element and magnetic induction element, respectively.

A copper pipe with outer diameter (OD) of 3/16″ (4.7625 mm) and wall thickness of 0.03″ (0.762 mm) was used to make the induction heating coil. The coil has 4.5 turns (N) with coil length (L) and coil inner diameter (R) (as shown in FIG. 8B). Water circulation, at constant temperature of 15° C., was used to cool down the coil during the excitation. A magnetic probe (Beehive Electronics 100C) with a spectrum analyzer (RIGOL DSA815) was used to measure the magnetic field along the coil axis. The magnetic field was measured at two voltages: 12V (the minimum voltage needed to excite the circuit) and 33 V. Due to the attenuation limits on the spectrum analyzer and induction heating of the magnetic field probe at high magnetic fields, the magnetic field could only be measured from 150 mm to 20 mm with reference to the edge of the coil.

In order to find the magnitude of the magnetic field inside the coil, the magnetic field was formulated as a function of distance from the center of a coil of width dw from the Biot-Savart as mentioned below:

$$\text{?} = \frac{{μ}_{o} ( nId \text{?} )}{2} \frac{{R}^{2}}{{[ {( \text{?} - \text{?} )}^{2} + {R}^{2} ]}^{2 / 2}} \qquad ( 5 )$$

$$\text{?} \text{indicates text missing or illegible when filed}$$

where n=N/L is the number of turns per length of the coil, R is radius of the ring, and I is the current through the ring (FIG. 2A). Integrating equation 1 from a=−L/2 to b=L/2, the Bₓ was found to be:

$$\text{?} = \frac{{μ}_{o} nI}{2} {R}^{2} \text{?} \frac{1}{{[ {( x - \text{?} )}^{2} + {R}^{2} ]}^{3 / 2}} dw = \frac{{μ}_{o} nI}{2} ( \frac{x - \text{?}}{\sqrt{{( \text{?} - \text{?} )}^{2} + {R}^{3}}} - \frac{x - b}{\sqrt{{( x - b )}^{2} + {R}^{2}}} ) \qquad ( 6 )$$

$$\text{?} \text{indicates text missing or illegible when filed}$$

Now the magnetic field in the center of the coil to be determined by:

$${B}_{x = 0} = {μ}_{o} nI \frac{L}{\sqrt{{L}^{2} + 4 {R}^{2}}} \qquad ( 7 )$$

Using the measured data for the amplitude of the magnetic field as a function of distance, equation (4) can be fit to estimate the magnetic field inside the coil to be H≈37 Oe and H≈100 Oe for excitation voltages of 12 V and 33 V, respectively.

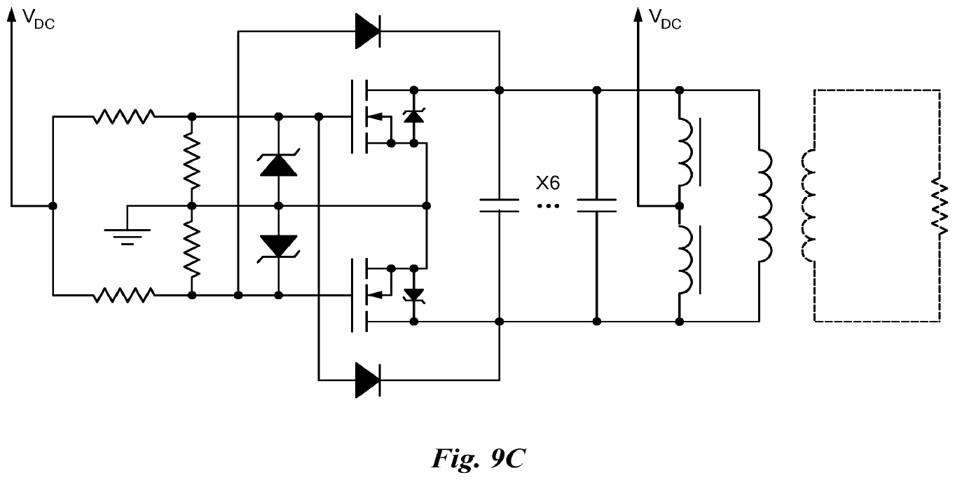

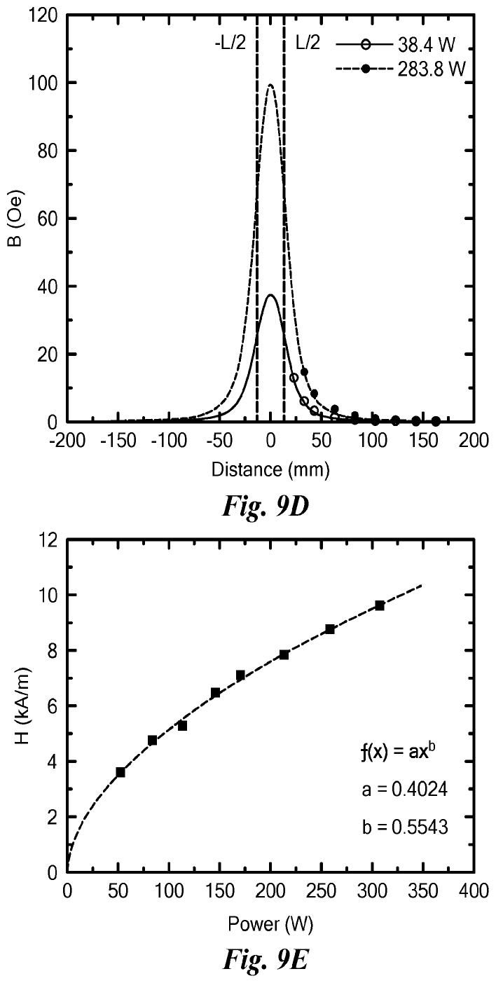

FIG. 9A illustrates specifications of the coil that was used for deriving equations 1 and 2. FIG. 9B illustrates the coil used for measuring the magnetic field characteristics along the coil axis. The images are taken before the coils are painted with color to prevent shorting of the coil during experiment. FIG. 9C illustrates the circuit schematic that was used to generate the high frequency alternating magnetic field. Magnetic nano-particles can be modeled as the secondary winding of a “transformer” with the primary winding being the induction coil. FIG. 9D illustrates a magnetic field along the coil axis. The model, equation (4), is fitted to the data to estimate the field inside the coil. FIG. 9D illustrates the magnetic field as a function of the input power.

The current (I) in equation 4, was found by measuring the voltage across the coil and using the following equation (assuming zero resistance across the coil) for impedance to find the current:

$$I = \frac{V}{2 π f \text{?}} \qquad ( 8 )$$

$$\text{?} \text{indicates text missing or illegible when filed}$$

where L is the inductance of the coil which can be found from the resonance frequency of the LC tank (i.e., L=1/C(2πf)²).

Fiber optic temperature monitoring technique was used to null the effect of magnetic noise in measuring the temperature, immunity to radio frequency (RF) and microwave radiation.

Output force of a pressure-driven cylindrical actuator, such as McKibben artificial muscle, is related to the contraction strain (ϵ), the differential pressure between the ambient and pressure inside the confined bladder (P), the initial bias angle of the braiding (θ₀), and the initial radius of the muscle (rₒ) (ref=Tondu and Lopez, 2000) as the following equation suggests:

F(P,ϵ)=(πrₒ²)P[a(1−ϵ)²−b] (9)

where a=3/tan²(θ₀) and b=1/sin²(θ₀0). This model was developed under the assumption of full transmission of the pressure inside the bladder to the external braiding without considering the stiffness of the muscle and geometry variations at both ends of the muscle. At zero strain, the blocking force can be found to be

$${F}_{block} = ( π r \begin{matrix}2 \\ 0\end{matrix} ) P [ a - b ]$$

and at zero force, the maximum strain ϵₘₐₓ=1−\sqrt{b/a}. To account for elasticity of the muscle the term P can be replaced by P−Pₑ where Pₑ is the pressure needed to elastically deform the bladder. The effect of the geometry variations at both ends of the muscle can also be included in the model by multiplying the strain with a correction factor k. From the braiding geometry the change in volume within the braided sleeve can be found to be:

$$V ( ϵ ) = {V}_{o} [ b ( 1 - ϵ ) - \frac{a}{3} {( 1 - ϵ )}^{3} ] \qquad ( 10 )$$

where V₀ is the initial volume of braided sleeve.

From Maxwell's relations isothermal compressbility (k) can be derived to be:

$$\text{?} = - \frac{1}{V} {( \frac{\partial V}{\partial P} )}_{T} \qquad ( 11 )$$

$$\text{?} \text{indicates text missing or illegible when filed}$$

which is the fractional change in volume of a system with pressure at constant temperature and can be expressed in terms of the thermal expansion coefficient (α) and thermal pressure coefficient (γ) as:

$$\text{?} = \frac{α}{γ} \qquad ( 12 )$$

$$\text{?} \text{indicates text missing or illegible when filed}$$

where α is defined as the fractional change in the volume of a system with temperature at constant pressure and can be written as:

$$α = \frac{1}{V} {( \frac{\partial V}{\partial T} )}_{P} \qquad ( 13 )$$

and γ is defined as the fractional change in the pressure of a system with temperature at constant volume and can be written as:

$$γ = {( \frac{\partial P}{\partial T} )}_{V} \qquad ( 14 )$$

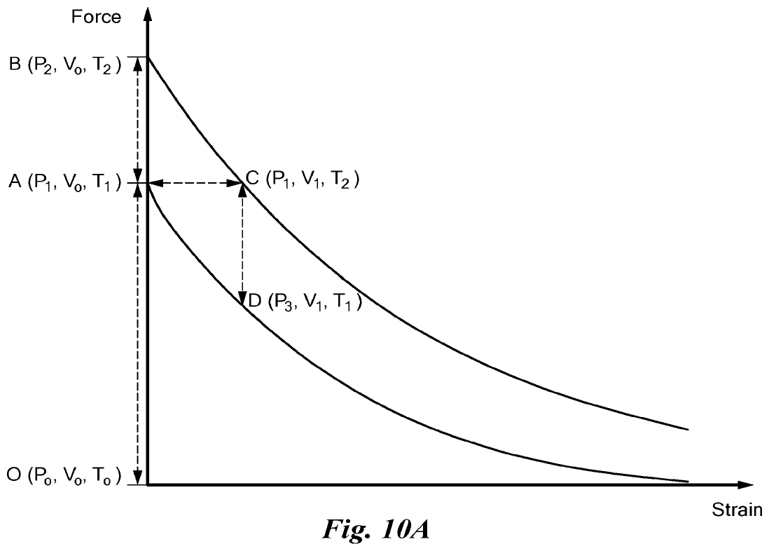

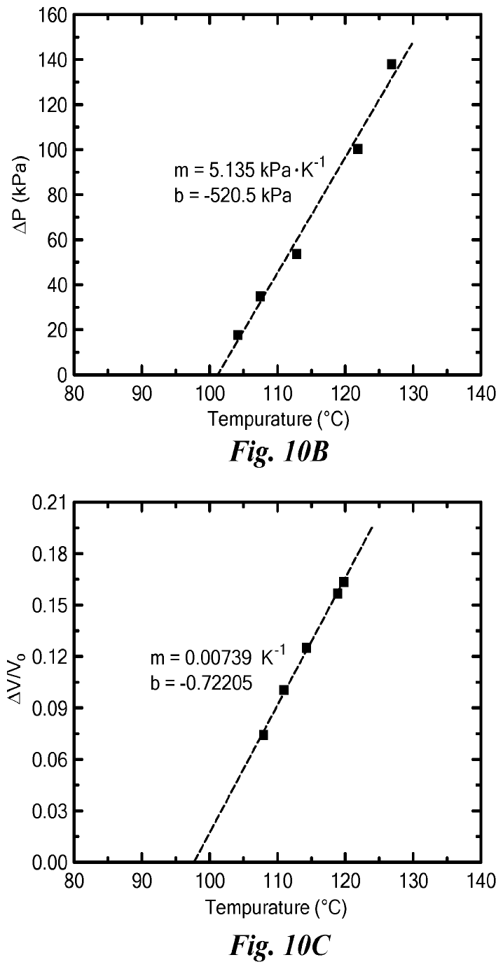

Both α and γ can be determined experimentally. Assuming that k is independent of P and V at low temperature and pressure ranges, equation (9) can be solved and combine with equation (8) to rewrite equation (7) as:

$$E ( \text{?} ϵ ) = ( π \text{?} ) [ γ ( T - {T}_{o} ) - \frac{1}{\text{?}} ln ( b ( 1 - ϵ ) - \frac{a}{3} {( 1 - ϵ )}^{3} ) ] [ {a ( 1 - ϵ )}^{2} - b ] \qquad ( 15 )$$

$$\text{?} \text{indicates text missing or illegible when filed}$$

where T₀ is the temperature at P=P_{D} and V=V₀. First the block force (F_{b}lock) was measured under isometric conditions (FIG. 10A) and equation (7) was used to find the pressure. γ is the slope of the differential pressure (ΔP) vs temperature (T) curve (as shown in FIG. 10B). Similarly, by increasing the temperature under isotonic conditions, the α can be found to be the slope of the normalized change in volume (ΔV/V₀) vs temperature (T) (as shown in FIG. 10).

FIG. 10A is a graph illustrating force vs strain for a device made according to Example III excited at temperatures T₁ and T₂. From state O to A and then B, the temperature of the muscle increases under an isometric condition (constant volume/strain). From state B to C, while the muscle is under excitation (constant T), the strain increases when the load decreases. From state C to A, the strain decreases under an isotonic (constant load) condition by reducing the excitation temperature (T). FIG. 10B shows a graph of the change in differential pressure as a function of temperature in the device. FIG. 10C shows a graph of the change in volume as a function of temperature in the device.

A core working principle of the actuation mechanism in Example III is based on liquid-to-gas phase transition of a fluid via induction heating. A more complete version of equation 3A, which includes the phase transition heat as well (assuming not all of the liquid evaporates), is as follows:

Q_{ind}=Q_{w}+Qᵥ+Qₗ (16)

where Q_{ind} is the heat generated by induction heating, Q_{w} is the heat required to increase the temperature of the system to the boiling point of the liquid, Qᵥ is the heat of vaporization, and Qₗ is the heat loss. Latex exhibits poor thermal conductivity and we can assume the heat loss to be negligible for the sake of analysis. Therefore, the heat into the system can be estimated from the following equation:

Q_{ind}=m[C(T_{b}−Tₒ)+Hᵥ] (17)

where m is the mass of the liquid, C is the heat capacity of the liquid, T_{b} is the boiling temperature, Tₒ is the temperature of the actuator before excitation, and Hᵥ is the heat of vaporization, as shown in the following table:

| Parameter | C(J/kg · K) | T_{b} (° C.) | Hᵥ(kJ/kg) |
|---|---|---|---|
| Water | 4200 | 100 | 2257 |
| Engineered Fluid | 1183 | 61 | 112 |

From equation 17, the input power to the system, and the excitation time we can find the efficiency to be <1% which is very similar to other thermal actuator technologies.

### EXAMPLE IV

### Magneto-thermal Soft Robotics

In Example IV, a wireless actuation device (actuator) is used that has a body comprised of a soft gripper or soft robotic finger. Due to the geometry of the gripper, the pressure generation mechanism of the actuator is decoupled from the body of the actuator. The pressure generation mechanism includes a container, housing a magnetic rod suspended in fluid, and coupled to an induction coil powered by an induction heater. Also, instead of using MNPs and water, a ferromagnetic rod (e.g., iron nail) and an engineered fluid with a boiling point of 61° Celsius were used within the pressure generation mechanism. FIGS. 11A-11E illustrate the components and the schematic of the electronics used to make and operate the magneto-thermal soft grippers of Example IV.

The soft grippers of Example IV were fabricated through a molding process. A mold was 3D printed with a Fused Deposition Modeling (FDM) 3D printer (FlashForge Creator Pro) that has a 0.1 mm layer resolution and print resolution of 0.2 mm. Polylactic Acid (PLA) thermoset filament (1.75 mm in diameter) was used to print the objects in a temperature-controlled chamber. Three different molds were fabricated to make models of the soft grippers used for examining the scalability of the magneto-thermal actuator.

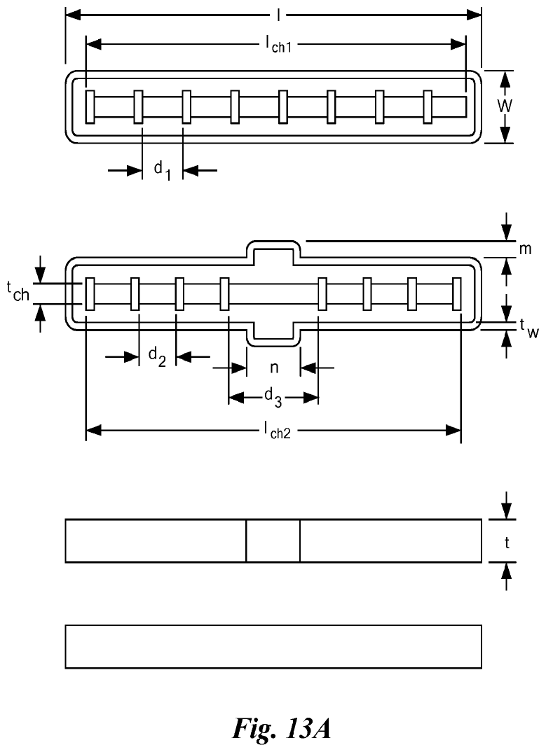

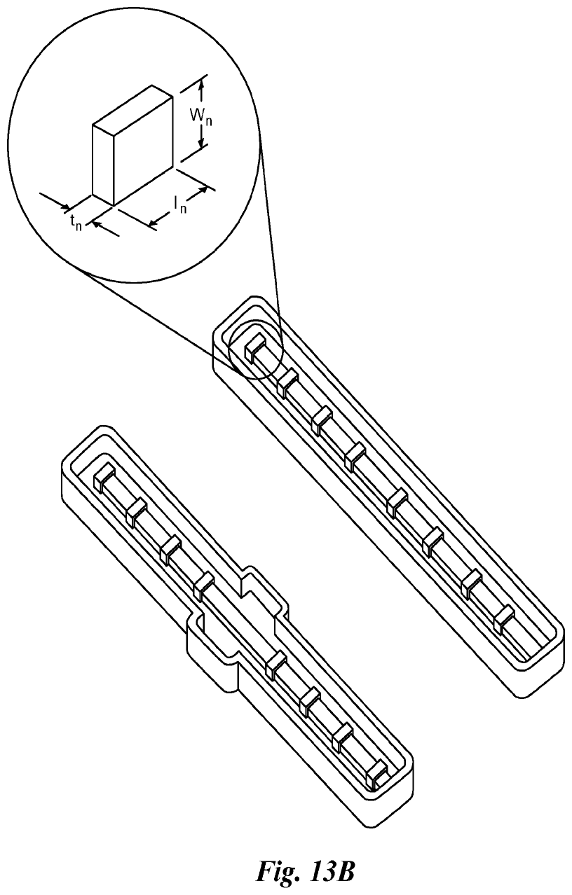

FIG. 13A shows the top view of the structure of the molds used to make the models of the soft grippers. FIG. 13B shows a side view of the structure of these molds. The channel and nodes for the actuator fluid passage can be seen in the center of the mold's cavity. The following table shows the dimension for different elements of the molds for small, medium, and large grippers. All units are in millimeters (mm).

| | Small | Medium | Large |
|---|---|---|---|
| l | 43 | 85.6 | 122 |
| w | 6 | 11.4 | 16 |
| t | 3.15 | 6.3 | 9 |
| m | 1.5 | 2.5 | 3.5 |
| n | 5.7 | 11.3 | 16 |
| t_{w} | 0.64 | 0.9 | 1.3 |
| t_{ch} | 0.9 | 2.2 | 3 |
| l_{ch1} | 39.4 | 79.75 | 113.5 |
| l_{ch2} | 37.75 | 76.2 | 109 |
| d₁ | 4 | 8.5 | 12 |
| d₂ | 3.76 | 7.8 | 11 |
| d₃ | 9.27 | 18.4 | 26.75 |
| lₙ | 2.3 | 4.3 | 7 |
| tₙ | 1 | 1.3 | 2 |
| wₙ | 1.4 | 3 | 4 |

EcoFlex™ 00-50 platinum-catalyzed silicone rubber was used as the body material for the soft grippers. The low elastic modulus (83 kPa) and large elongation at break (980%) made the EcoFlex an excellent material for the application in soft robotics. The material was prepared by mixing a one-to-one ratio of the two precursors together, followed by de-gassing the mixture in a desiccator for 5 mins. A rotary vacuum pump was used to generate the required vacuum in the desiccator. The mixture was then transferred to the molds and degassed further in the desiccator and cured at 65° C. for 10 min. To prevent the gripper side of the actuator from expanding, a piece of cotton fabric was adhered to it by coating the fabric with EcoFlex™ 00-50. The cotton fabric was chosen due its porous property which allowed it to act as a good adhesion layer to the gripper. Moreover, fabrics are flexible and exhibit the required planar stiffness for this purpose. The inlet channel to the gripper was molded separately and attached to the gripper by using another application of EcoFlex™ 00-50.

The induction heating coil of Example III may be used in the device of Example IV.

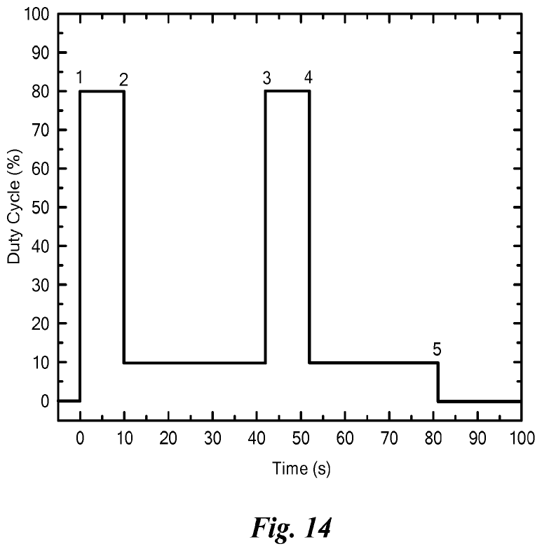

The soft grippers were excited by a DC magnetic field produced by input power from two lithium-ion batteries (as shown in FIG. 11E). As illustrated in the graph of FIG. 14, the input power (voltage) was pulse-width-modulated (PWM) with each duty cycle of 100%, 80%, and 10 to control the pressure developed inside the actuator, in turn, controlling the position of the gripper. In a first excitation cycle, the actuator was excited at a 80% duty cycle, and when the actuator reached the desired position, the duty cycle was reduced to a 10% duty cycle to hold the actuator in place and prevent bursting. After 32 s of cooling, the gripper was excited with the same duty cycle pattern again. The excitation pattern was repeated to demonstrate the controllability of the mechanism. In DC excitation, the actuator was excited until it grabbed an object and then was turned off.

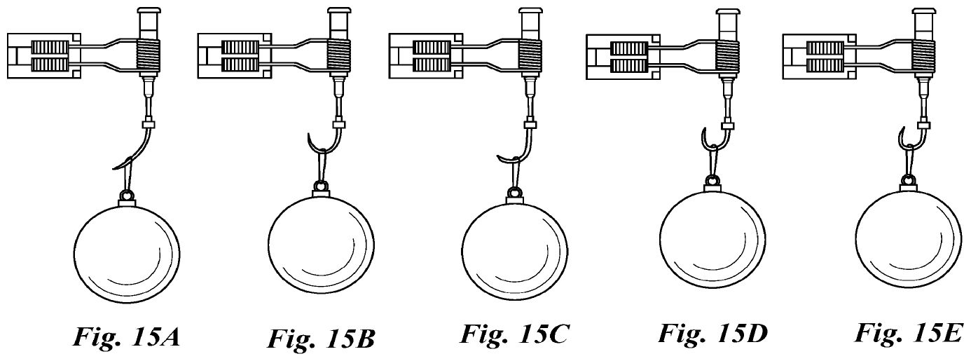

FIGS. 15A-15E shows excitation of a soft gripper, using the actuator in Example IV, according to the duty cycle pattern of FIG. 14. FIG. 15A shows the actuator with the soft gripper configured to pick-up a ball positioned on a stand. The associated parameters are: m_{ball}(g)=14; d_{ball}(mm)=75; V_{fluid}(mL)=50; and m_{gripper}(g)=2. FIG. 15B shows excitation of the soft gripper at duty cycle=80% for time (t)=10 s at power (P)=32 W (at 8 V). FIG. 15C shows excitation of the soft gripper at duty cycle=10% for time (t)=42 s with the stand removed from under the ball. FIG. 15D shows excitation of the soft gripper at duty cycle=80% for time (t)=52 s. FIG. 15E shows the excitation of the soft gripper at duty cycle=10% for time (t)=81 s; and pressure (P)=51.5 kPa.

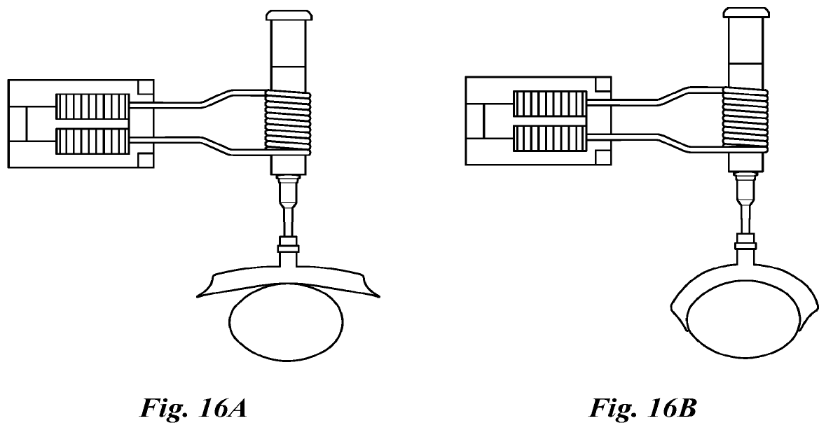

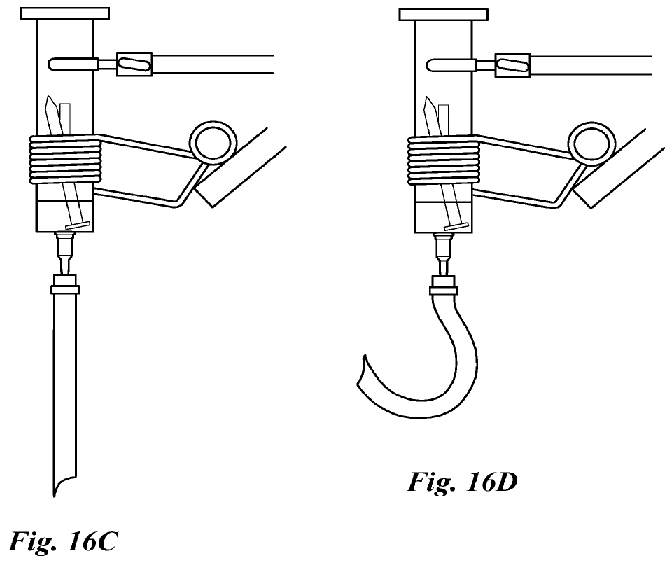

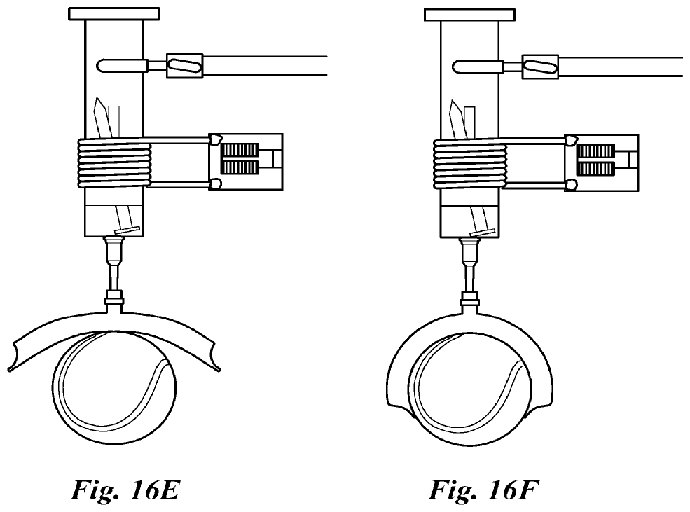

FIGS. 16A-16F shows other examples of such excitation of soft grippers, using the actuator in Example IV, to pick-up various objects. In FIGS. 16A-16B, the soft gripper is excited to pick-up a cooked egg according to the following parameters: m_{egg}(g)=65; d_{egg}(mm)=60×40; V_{fluid}(mL)=15; P(W)=32 (at 8 V); duty cycle=100%; t_{excitation}(s)=20; d_{gripper}(mm)=85×10×6; m_{gripper}(g)=11; P(kPa)=80.4. In FIGS. 16C-16D, the soft gripper is excited to pick-up an object according to the following parameters: V_{fluid}(mL)=50; P(W)=32 (at 8 V); duty cycle=100%; t_{excitation}(s)=130; d_{gripper}(mm)=120×15×8; m_{gripper}(g)=15; P(kPa)=80.4. In FIGS. 16E-F, the soft gripper is excited to pick-up a tennis ball according to the following parameters: m_{ball}(g)=57; d_{ball}(mm)=65; V_{fluid}(mL)=50; P(W)=32 (at 8 V); duty cycle=100%; t_{excitation}(s)=60; d_{gripper}(mm)=120×15×8; m_{gripper}(g)=21; P(kPa)=80.4. In FIGS. 16E-16F, the excitation time is timed right before the bending of the gripper occurs. In all grippers, the mass of the connector is included in the mass of the gripper.

Heat management in thermal actuation plays a crucial role in determining the actuation rate in Example IV. Thermal mass, the heat conductivity of the materials, and cooling mechanism are three major parameters that define the actuation performance. Aside from engineering the materials properties, the cooling rate can be reduced by scaling down the actuator size. To examine the scalability, grippers of different sizes were fabricated and actuated with different volumes of the engineered fluid (i.e., 3 mL, 15 mL, and 50 mL). The gripper filled with 3 mL fluid exhibited an actuation response time of 10 s with a cooling time of 150 s, while the gripper filled with 50 mL fluid showed an actuation response time of 130 s with a cooling time of more than 300 s. Although it cannot be confidently deduced that the actuation rate is inversely proportional to the size of the actuator itself, it was determined that the output force generated by the actuator directly scales with its size.

In Example IV, high-frequency magnetic fields are used to boil the fluid and generate pressure inside the pneumatic actuator. It has been demonstrated that soft and thin materials can be coated with permanent micro-magnets and actuated with magnetic forces from a magnet or a coil (i.e., DC magnetic field) (M. M. Schmauch et al., “Chained iron microparticles for directionally controlled actuation of soft robots,” ACS Appl. Mater. Interfaces 9.13, 11895-11901 (2017); Y. Kim et al., “Printing ferromagnetic domains for untethered fast-transforming soft materials,” Nature 558, 274-279 (2018), each incorporate herein by reference.). One of the advantages of using the DC magnetic field is the fast response time that it can provide. This fast response time often translates to a high-power density actuation dynamic. However, the generated force by a magnetic field is a function of r⁻², which often leads to a small energy density actuation dynamic when the distance (e.g., r) is considerable. In contrast, due to the nature of heating (e.g., heat capacity), excitation with an AC magnetic field has the advantage of generating large forces but with slow actuation rates.

This mechanism of Example IV is scalable such that it can be employed in the design of soft robotic grippers. One of the benefits of the scalability is the reduction in power consumption to the point that the actuator controlling the grippers can be powered with only two lithium-ion batteries, which is very important for untethered applications. Examples include using the actuator in a confined and remote environment where no power transmission line is readily available.

The embodiments of the invention described herein are intended to be merely exemplary; variations and modifications will be apparent to those skilled in the art. All such variations and modifications are intended to be within the scope of the present invention as defined in any appended claims.

1. A device for wireless actuation, the device comprising:
a bladder having an inner surface and an outer surface, the inner surface forming an interior area, the bladder configured to expand or retract so as to change an area of the interior area;
a container fluidly coupled to the bladder via a connector, the container housing a magnetic rod suspended in a fluid medium, the magnetic rod configured to interact with a magnetic field which produces a phase transition of the fluid medium, causing the fluid medium to be transferred to the interior area of the bladder via the connector and causing the bladder to expand;
an induction coil disposed around the container, a first end of the induction coil coupled to an interior of the container; and
an induction heater coupled to a second end of the induction coil, the induction heater powering the induction coil, such that the induction coil generates the magnetic field within the interior of the container.

2. A device according to claim 1, wherein the bladder is made of silicone rubber and/or is a compliant bladder.

3. A device according to claim 1, wherein the bladder is a robotic gripper or a soft robot that operates using pneumatic or hydraulic pressure.

4. A device according to claim 1, wherein the container is a glass syringe or made of a non-ferromagnetic material.

5. A device according to claim 1, wherein the fluid medium is an engineered fluid with a boiling point of 61 degrees Celsius.

6. A device according to claim 1, wherein the connector is a dispensing needle.

7. A device according to claim 1, wherein the container is sealed with a metallic plate.

8. A device according to claim 7, wherein the metallic plate is coupled to a heat sink.

9. A device of claim 1, wherein the magnetic rod is configured to increase in temperature due to the interaction with the magnetic field and the increased temperature of the magnetic rod causes the phase transition of the fluid medium.

10. A device of claim 9, wherein the phase transition of the fluid medium includes gas generated within the container by the magnetic rod, such that the gas is transferred to the interior area of the bladder via the connector and causes the bladder to expand.

11. A device of claim 10, wherein the phase transition of the fluid medium causes the bladder to expand due to pressure caused by the gas within the interior area of the bladder.

12. A device according to claim 1, further comprising a controller in communication with the induction heater via a power switch and configured to control a voltage provided to the induction coil.
